(19) United States
(12) Patent Application Publication
(10) Pub. No.: US 2012/0068082 A1
(43) Pub. Date: Mar. 22, 2012

(54) ION GENERATION APPARATUS AND ELECTRIC EQUIPMENT

(76) Inventor: Yoshiyuki Noda, Osaka (JP)

(21) Appl. No.: 13/375,897

(22) PCT Filed: Apr. 22, 2010
(86) PCT No.: PCT/JP2010/057134

§ 371 Date: Dec. 2, 2011

(30) Foreign Application Priority Data
Jun. 5, 2009 (JP) 2009-136128
Dec. 21, 2009 (JP) 2009-289339

(51) Int. Cl. H01J 27/02

(52) U.S. Cl. 250/423 R

(57) ABSTRACT

An ion generation apparatus includes an opposing electrode, a discharge electrode for generating ions between itself and the opposing electrode, and a slider constructed to be movable between a contact state in which contact with the discharge electrode is established and a non-contact state in which contact is not established in order to clean the discharge electrode. Thus, an ion generation apparatus and electric equipment capable of preventing lowering in ion generation efficiency even in an environment where there is much dust can be obtained.

### TECHNICAL FIELD

The present invention relates to removal of contamination of a discharge portion of an ion generation apparatus and electric equipment.

### BACKGROUND ART

An ion generation apparatus has conventionally been used for purification, sterilization, deodorization, or the like of air in a room. Many of such apparatuses equipped with an ion generation electrode emit positive ions and negative ions (hereinafter collectively referred to as positive and negative ions) generated through corona discharge through an ion emission port provided in a housing. These positive and negative ions function to purify, deodorize or sterilize air.

Ion generation elements include, in particular, an element having a needle-shaped metal or the like as a discharge electrode and having a metal plate, a grid or the like arranged opposed thereto (see, for example, Japanese Patent Laying-Open No. 2005-13649), or an element employing ground as an opposing electrode without particularly arranging an opposing electrode. With the ion generation element of this type, air between the discharge electrode and the opposing electrode or the ground plays a role as an insulator. With this ion generation element, a discharge phenomenon occurs in such a manner that electric field concentration occurs at an acute tip end of the electrode when a high voltage is applied to the electrode and air extremely close to that tip end breaks down.

Though many ion generation apparatuses utilizing a discharge phenomenon have been put into practical use, these ion generation apparatuses are normally constituted of an ion generation element for generating ions, a high-voltage transformer for supplying a high voltage to the ion generation element, a high-voltage transformer drive circuit for driving the high-voltage transformer, and a power supply input portion such as a connector.

An ion generation apparatus utilizing a discharge phenomenon is exemplified by an apparatus described in Japanese Patent Laying-Open No. 2002-374670. In the ion generation apparatus described in this publication, a high-voltage transformer for supplying a high voltage to an ion generation electrode and a drive circuit for driving the high-voltage transformer are mounted in a case.

### CITATION LIST

### Patent Literature

PTL 1: Japanese Patent Laying-Open No. 2005-13649
PTL 2: Japanese Patent Laying-Open No. 2002-374670

### SUMMARY OF INVENTION

### Technical Problem

As the ion generation apparatus as described above is used for a long period of time, dust and other contaminants included in an airflow adhere to the ion generation electrode and a discharge surface will soon be covered with such contaminants. When such a state is caused, corona discharge for ion generation is impeded and ion generation efficiency may be lowered.

The present invention was made in view of the above-described problems, and an object of the present invention is to provide an ion generation apparatus and electric equipment capable of preventing lowering in ion generation efficiency even in an environment where there is much dust.

### Solution to Problem

An ion generation apparatus according to the present invention includes a discharge electrode for generating ions and a cleaning member constructed to be movable between a contact state in which contact with the discharge electrode is established for cleaning the discharge electrode and a non-contact state in which contact with the discharge electrode is not established.

According to the ion generation apparatus of the present invention, since the cleaning member can move between the contact state and the non-contact state, during cleaning of the discharge electrode, the discharge electrode can be cleaned by bringing the cleaning member into contact with the discharge electrode. In addition, during discharge by the discharge electrode, the cleaning member is prevented from being in contact with the discharge electrode, so that the cleaning member can be prevented from impeding discharge. As the cleaning member can thus remove contamination of the discharge electrode and the cleaning member does not impede discharge either, lowering in ion emission efficiency can be prevented even in an environment where there is much dust.

The ion generation apparatus above preferably further includes an induction electrode for generating ions between the induction electrode and the discharge electrode.

Thus, discharge can be caused to occur between the discharge electrode and the induction electrode.

In the ion generation apparatus above, preferably, the cleaning member has a bending portion for converting rotational motion into linear motion.

Thus, large linear motion can be obtained through rotational motion.

In the ion generation apparatus above, preferably, the bending portion of the cleaning member is smaller in dimension in a direction of width than a portion other than the bending portion of the cleaning member.

Thus, flexibility of the bending portion can be ensured and the bending portion can be implemented with a simplified construction.

In the ion generation apparatus above, preferably, the cleaning member is made of a thin metal plate.

Thus, the bending portion for converting rotational motion into linear motion can be implemented and reduction in size of the cleaning member is facilitated.

The ion generation apparatus above is preferably configured to stop power feed to the discharge electrode while the cleaning member is in the contact state.

Thus, the cleaning member can be prevented from impeding discharge while the discharge electrode is discharging.

In the ion generation apparatus above, preferably, the discharge electrode has a needle-like tip end and serves to generate ions at the tip end. The ion generation apparatus further includes a motor allowing the cleaning member to move.

Since the motor thus serves as a drive source for allowing the cleaning member to move, control of a moving speed is facilitated. Thus, since a time period during which the cleaning member is in contact with the discharge electrode can be long, removal of deposits is facilitated. In addition, since the motor serves as the drive source, a distance of travel of the cleaning member can be long, a large area of a portion of the cleaning member in contact with the discharge electrode can be ensured and removal of deposits is facilitated.

In the ion generation apparatus above, preferably, the cleaning member has a rack gear, and the motor has a pinion gear engaged with the rack gear.

Thus, rotational motion of the motor can be converted into linear motion of the cleaning member.

The ion generation apparatus above preferably further includes an induction electrode arranged opposed to the discharge electrode. The other end opposite to the needle-like one end of the discharge electrode is located under the induction electrode, and the cleaning member is located above the induction electrode.

In the ion generation apparatus above, preferably, the induction electrode has a through hole for emitting ions, and the through hole has a keyhole shape formed by combining a circular portion and a rectangular portion.

Thus, even when the cleaning member is located above the induction electrode, the discharge electrode located under the induction electrode can be cleaned.

The ion generation apparatus above preferably further includes an induction electrode arranged opposed to the discharge electrode. The other end opposite to the needle-like one end of the discharge electrode is located under the induction electrode, and the cleaning member is located under the induction electrode.

Thus, the discharge electrode can be cleaned with the cleaning member regardless of a shape of an ion emission hole in the induction electrode.

The ion generation apparatus above preferably further includes a substrate for supporting the discharge electrode. The cleaning member is constructed to be able to clean also a surface of the substrate simultaneously with cleaning of the discharge electrode.

Thus, not only cleaning of the discharge electrode but also cleaning of the surface of the substrate supporting the discharge electrode can simultaneously be performed.

The ion generation apparatus above preferably further includes a case accommodating at least the discharge electrode therein. The case is two-dimensionally partitioned into a region accommodating a portion transmitting drive force from the motor to the cleaning member and a region accommodating an ion generation portion including the discharge electrode. A part of the region accommodating the ion generation portion is molded with an insulating resin.

As thus two-dimensional partition into the region accommodating the portion transmitting drive force and the region accommodating the ion generation portion is made, only a high-voltage portion in the region accommodating the ion generation portion can selectively be molded with an insulating resin and insulation can readily be reinforced.

The ion generation apparatus above preferably further includes a detection member for detecting a position of movement of the cleaning member. The ion generation apparatus is configured to be able to control positional relation between the cleaning member and the discharge electrode based on a position of the cleaning member detected by the detection member.

The discharge electrode can thus efficiently be cleaned.

In the ion generation apparatus above, preferably, the cleaning member includes at least two brush members. Each of the two brush members has a shaft extending in a direction of movement of the cleaning member and a brush extending toward an outer circumference with the shaft being a center. The cleaning member is constructed to be able to clean the discharge electrode while the tip end of the discharge electrode lies between the two brush members.

Electric equipment according to the present invention includes the ion generation apparatus described in any paragraph above and a blowing portion for sending ions generated by the ion generation apparatus to the outside of the electric equipment over a blown airflow.

According to the electric equipment of the present invention, ions generated by the ion generation apparatus can be sent over an airflow by means of the blowing portion. Therefore, for example, ions can be emitted to the outside of air-conditioning equipment and ions can be emitted into or out of refrigerating equipment.

### Advantageous Effects of Invention

As described above, according to the ion generation apparatus and the electric equipment of the present invention, lowering in ion emission efficiency can be prevented even in an environment where there is much dust.

### BRIEF DESCRIPTION OF DRAWINGS

FIG. 1 is a plan view schematically showing a construction of an ion generation apparatus in a first embodiment of the present invention.

FIG. 2 is a front view schematically showing a construction of the ion generation apparatus in the first embodiment of the present invention.

FIG. 3 is a side view schematically showing a construction of the ion generation apparatus in the first embodiment of the present invention.

FIG. 4 is a plan view schematically showing a state in which a cover of the ion generation apparatus in the first embodiment of the present invention is removed.

FIG. 5 is a schematic cross-sectional view showing a cross-section corresponding to the line V-V in FIG. 4.

FIG. 6 is a schematic cross-sectional view showing the state in FIG. 5 with a slider 20 being not shown.

FIG. 7 is a schematic cross-sectional view showing a cross-section corresponding to the line VII-VII in FIG. 4.

FIG. 8 is a schematic cross-sectional view showing a cross-section corresponding to the line VIII-VIII in FIG. 4, with a solenoid 15 being not shown.

FIG. 9 is an exploded view schematically showing a construction of a deposit removal function portion included in the ion generation apparatus in the first embodiment of the present invention.

FIG. 10 is a diagram schematically showing a construction of solenoid 15 included in the ion generation apparatus in the first embodiment of the present invention.

FIG. 11 is a plan view schematically showing a construction of slider 20 included in the ion generation apparatus in the first embodiment of the present invention.

FIG. 12 is a front view schematically showing a construction of slider 20 included in the ion generation apparatus in the first embodiment of the present invention.

FIG. 13 is a side view schematically showing a construction of slider 20 included in the ion generation apparatus in the first embodiment of the present invention.

FIG. 14 is a perspective view schematically showing a construction of slider 20 included in the ion generation apparatus in the first embodiment of the present invention.

FIG. 15 is a schematic front view (A) and a partial enlarged view (B) showing a construction in which a thin plate made of resin is bonded to a cleaning portion of the slider.

FIG. 16 is a schematic front view (A) and a partial enlarged view (B) showing a construction in which a brush portion made of resin is attached to the cleaning portion of the slider.

FIG. 17 is a functional block diagram of the ion generation apparatus in the first embodiment of the present invention, showing electrical connection of each functional element.

FIG. 18 is a diagram, with (A) to (C) each illustrating a manner of cleaning of a discharge electrode in the ion generation apparatus in the first embodiment of the present invention.

FIG. 19 is a plan view schematically showing a contact state in which slider 20 is in contact with the discharge electrode in the ion generation apparatus in the first embodiment of the present invention.

FIG. 20 is a cross-sectional view showing a cross-section corresponding to FIG. 5 and schematically showing the contact state in which slider 20 is in contact with the discharge electrode in the ion generation apparatus in the first embodiment of the present invention.

FIG. 21 is a plan view schematically showing a construction of an ion generation apparatus in a second embodiment of the present invention.

FIG. 22 is a front view schematically showing a construction of the ion generation apparatus in the second embodiment of the present invention.

FIG. 23 is a side view schematically showing a construction of the ion generation apparatus in the second embodiment of the present invention.

FIG. 24 is a plan view schematically showing a state in which a cover is removed from the construction of the ion generation apparatus in the second embodiment of the present invention.

FIG. 25 is a schematic cross-sectional view showing a cross-section corresponding to the line XXV-XXV in FIG. 24.

FIG. 26 is a schematic cross-sectional view showing a cross-section corresponding to the line XXVI-XXVI in FIG. 24.

FIG. 27 is a bottom view schematically showing a construction of the ion generation apparatus in the second embodiment of the present invention.

FIG. 28 is a schematic cross-sectional view showing a cross-section corresponding to the line XXVIII-XXVIII in FIG. 24 and showing a state in which the cover is attached.

FIG. 29 is a plan view schematically showing a construction of an ion generation circuit portion included in the ion generation apparatus in the second embodiment of the present invention.

FIG. 30 is a front view schematically showing a construction of the ion generation circuit portion included in the ion generation apparatus in the second embodiment of the present invention.

FIG. 31 is a bottom view schematically showing a construction of the ion generation circuit portion included in the ion generation apparatus in the second embodiment of the present invention.

FIG. 32 is a side view schematically showing a construction of the ion generation circuit portion included in the ion generation apparatus in the second embodiment of the present invention.

FIG. 33 is a front view schematically showing a construction of a motor control circuit portion and a construction of a deposit removal portion included in the ion generation apparatus in the second embodiment of the present invention.

FIG. 34 is a bottom view schematically showing a construction of the motor control circuit portion and a construction of the deposit removal portion included in the ion generation apparatus in the second embodiment of the present invention.

FIG. 35 is a side view schematically showing a construction of the motor control circuit portion and a construction of the deposit removal portion included in the ion generation apparatus in the second embodiment of the present invention.

FIG. 36 is a plan view schematically showing a construction of a cleaning slider included in the ion generation apparatus in the second embodiment of the present invention.

FIG. 37 is a schematic cross-sectional view showing a cross-section corresponding to the line XXXVII-XXXVII in FIG. 36.

FIG. 38 is a schematic cross-sectional view showing a cross-section corresponding to the line XXXVIII-XXXVIII in FIG. 36.

FIG. 39 is a perspective view schematically showing a construction of a case included in the ion generation apparatus in the second embodiment of the present invention.

FIG. 40 is a functional block diagram of the ion generation apparatus in the second embodiment of the present invention, showing electrical connection of each functional element.

FIG. 41 is a partial enlarged cross-sectional view for illustrating a cleaning operation in the ion generation apparatus in the second embodiment of the present invention, with (A) showing a state in which a cleaning portion is not in contact with a discharge electrode and (B) showing a state in which the cleaning portion is in contact with the discharge electrode.

FIG. 42 is a plan view schematically showing a construction of a cleaning slider included in an ion generation apparatus in a third embodiment of the present invention.

FIG. 43 is a schematic cross-sectional view showing a cross-section corresponding to the line XLIII-XLIII in FIG. 42.

FIG. 44 is a schematic cross-sectional view showing a cross-section corresponding to the line XLIV-XLIV in FIG. 42.

FIG. 45 is a plan view schematically showing a state in which a cover is removed from a construction of an ion generation apparatus in a fourth embodiment of the present invention.

FIG. 46 is a schematic cross-sectional view showing a cross-section corresponding to the line XLVI-XLVI in FIG. 45.

FIG. 47 is a schematic cross-sectional view showing a cross-section corresponding to the line XLVII-XLVII in FIG. 45.

FIG. 48 is a plan view schematically showing a construction of a cleaning slider included in an ion generation apparatus in a fifth embodiment of the present invention.

FIG. 49 is a schematic cross-sectional view showing a cross-section corresponding to the line XLIX-XLIX in FIG. 48.

FIG. 50 is a partial enlarged cross-sectional view for illustrating a cleaning operation in the ion generation apparatus in the fifth embodiment of the present invention, with (A) showing a state in which a cleaning portion is not in contact with a discharge electrode and (B) showing a state in which the cleaning portion is in contact with the discharge electrode.

FIG. 51 is a perspective view schematically showing a construction of an air cleaner including the ion generation apparatus in an embodiment of the present invention.

FIG. 52 is an exploded view of the air cleaner showing a manner of arrangement of the ion generation apparatus in the air cleaner shown in FIG. 51.

### DESCRIPTION OF EMBODIMENTS

An embodiment of the present invention will be described hereinafter with reference to the drawings.

### First Embodiment

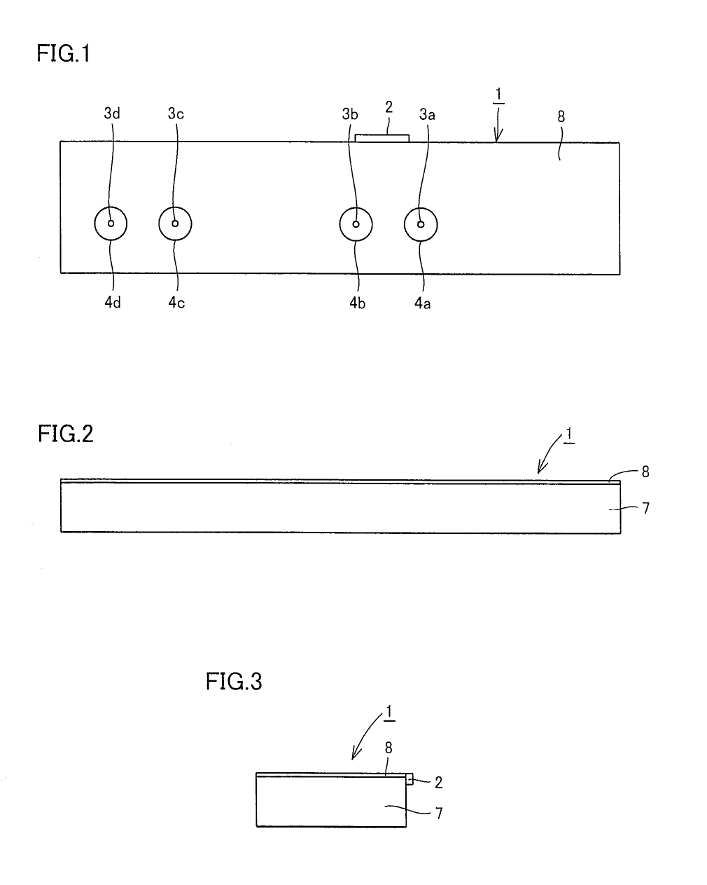

An overall construction of an ion generation apparatus in a first embodiment of the present invention will initially be described with reference to FIGS. 1 to 7.

Referring to FIGS. 1 to 7, an ion generation apparatus 1 in the present embodiment mainly has a power supply input connector 2, ion generation elements 5 and 6, a case 7, a cover 8, a substrate 12, a circuit unit 13, and a deposit removal mechanism portion 21.

Referring to FIGS. 1 to 3, case 7 and cover 8 constitute an outer shell of ion generation apparatus 1. In cover 8, a plurality of (for example, four) through holes 4a to 4d are formed. These through holes 4a to 4d are opening portions for emitting ions generated through corona discharge to the outside of case 7.

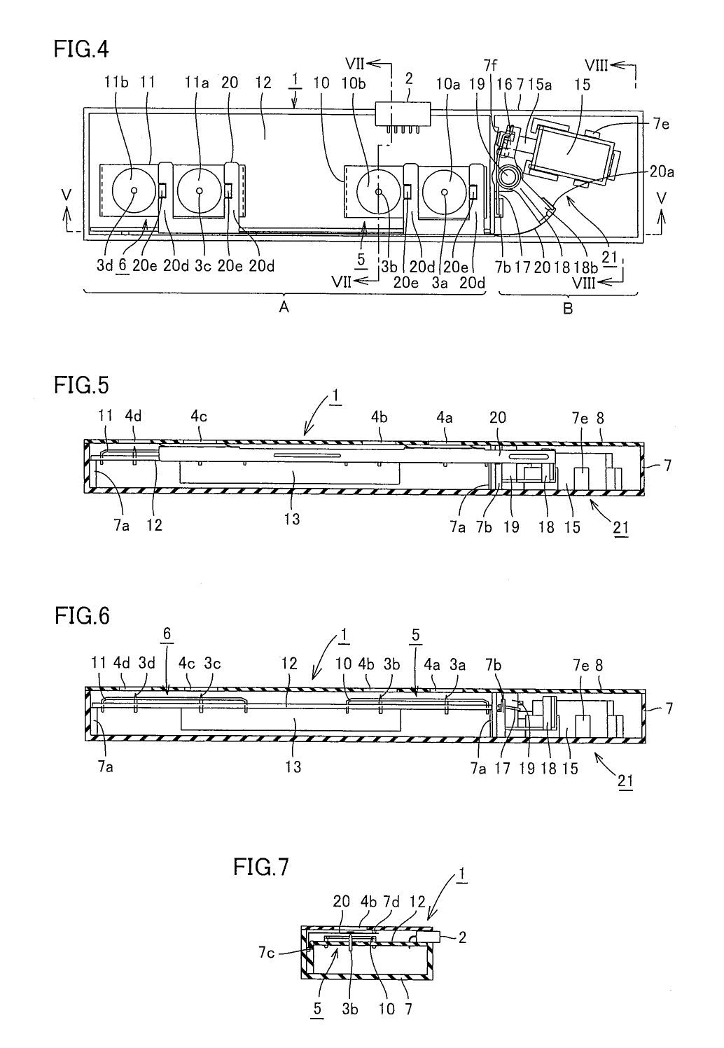

Referring to FIGS. 4 to 7, power supply input connector 2, ion generation elements 5 and 6, substrate 12, circuit unit 13, and deposit removal mechanism portion 21 are accommodated in case 7.

The inside of case 7 is divided into an ion generation block A and a deposit removal block B. In ion generation block A, power supply input connector 2, ion generation elements 5 and 6, support substrate 12, and circuit unit 13 are arranged, and in deposit removal block B, deposit removal mechanism portion 21 is arranged.

Circuit unit 13 includes a high-voltage circuit, a high-voltage transformer, and a high-voltage transformer drive circuit, however, FIGS. 4 to 7 do not show details thereof but show circuit unit 13 collectively.

Ion generation elements 5 and 6 serve to generate at least any of positive ions and negative ions, for example, through corona discharge. Ion generation element 5 is constituted of discharge electrodes 3a and 3b and an opposing electrode (induction electrode) 10. Meanwhile, ion generation element 6 is constituted of discharge electrodes 3c and 3d and an opposing electrode (induction electrode) 11.

Each of opposing electrodes 10 and 11 is supported by support substrate 12. Each of opposing electrodes 10 and 11 is made of a one-piece metal plate and they have a plurality of through holes 10a, 10b, 11a, and 11b provided in respective top plate portions, in number as many as the number of discharge electrodes. These through holes 10a, 10b, 11a, and 11b are opening portions for emitting ions generated through corona discharge to the outside of case 7.

In the present embodiment, the number of through holes 10a, 10b, 11a, and 11b is set, for example, to four, and a two-dimensional shape of through holes 10a, 10b, 11a, and 11b is, for example, circular.

Each of discharge electrodes 3a to 3d has a needle-like tip end. Support substrate 12 has a through hole (not shown) for insertion of each of these discharge electrodes 3a to 3d.

Each of needle-like discharge electrodes 3a to 3d is supported as it is inserted or press-fitted into the through hole in support substrate 12 to penetrate support substrate 12. Thus, needle-like one end of each of discharge electrodes 3a to 3d protrudes on a front surface side of support substrate 12, and the other end protruding on a back surface side of support substrate 12 is electrically connected to support substrate 12 by soldering.

Support substrate 12 is arranged in ion generation block portion A in case 7 while it supports opposing electrodes 10 and 11 and discharge electrodes 3a to 3d. In this state, support substrate 12 is positioned at a defined height by a support substrate holding wall 7a in ion generation block A in case 7 as shown in FIGS. 5 and 6. In addition, opposing electrodes 10 and 11 are each positioned at a defined height as fixed to support substrate 12, as shown in FIGS. 5 and 6. As thus support substrate 12 and opposing electrodes 10 and 11 are each positioned at a defined height, opposing electrodes 10 and 11 can be positioned with respect to support substrate 12 in a direction of its thickness.

While opposing electrodes 10 and 11 and support substrate 12 are supported by case 7, discharge electrodes 3a to 3d are arranged such that each of the needle-like tip ends is positioned in the center of each circular through hole 10a, 10b, 11a, 11b in opposing electrode 10, 11 as shown in FIG. 4. In addition, on the back surface (a soldering surface) of support substrate 12, such a constituent element as circuit unit 13 (the high-voltage circuit, the high-voltage transformer, and the high-voltage transformer drive circuit) is attached.

Power supply input connector 2 is supported by support substrate 12, and it is constructed such that a part thereof is exposed to the outside of case 7 so as to be electrically connected to the outside of case 7.

Cover 8 of case 7 has through holes 4a to 4d for ion emission in a wall portion opposed to respective through holes 10a, 10b, 11a, and 11b in opposing electrodes 10 and 11. Thus, ions generated by each of ion generation elements 5 and 6 are emitted to the outside of ion generation apparatus 1 through these through holes 4a to 4d. Discharge electrodes 3a and 3b of ion generation element 5 serve, for example, to generate positive ions, while discharge electrodes 3c and 3d of ion generation element 6 serve, for example, to generate negative ions. Therefore, one through holes 4a and 4b provided in case cover 8 serve as a positive ion generation portion, and the other through holes 4c and 4d serve as a negative ion generation portion.

For preventing electric shock, each of through holes 4a to 4d for ion emission is set to have a diameter smaller than a diameter of through hole 10a, 10b, 11a, 11b of opposing electrode 10, 11 such that a hand is not in direct contact with opposing electrode 10, 11 which is a power feed portion.

A deposit removal function will now be described with reference to FIGS. 4 and 8 to 10.

Referring first to FIG. 4, deposit removal mechanism portion 21 mainly has a solenoid 15, a coupling plate 16, a spring 17, an arm 18, a rotation shaft 19, and a slider (cleaning member) 20. A basic mechanism portion except for a part of slider 20 of this deposit removal mechanism portion 21 is arranged in deposit removal block B within case 7.

Referring to FIGS. 4, 8 and 9, solenoid 15 is fitted into a solenoid guide 7e in case 7 and thus held in case 7.

Referring to FIG. 10, solenoid 15 has a coil and a plunger 15a which is a rod-shaped member inserted in the coil. An operation of plunger 15a can be controlled by power feed to the coil. Namely, the operation of plunger 15a is controlled such that it is retracted in the coil as power feed to the coil is turned ON and it becomes free as power feed to the coil is turned OFF.

Referring to FIGS. 4, 8 and 9, coupling plate 16 is held by plunger 15a of solenoid 15. Spring 17 is fitted to rotation shaft 19 that stands from a bottom surface of case 7. One end of spring 17 is held by coupling plate 16 and the other end of spring 17 is held by a spring holding portion 7b of case 7. Coupling plate 16 is pulled in a direction in which plunger 15a is pulled out of the coil of solenoid 15 with the force of spring 17.

Referring mainly to FIG. 4, a tip end of plunger 15a is constructed to stop as it abuts a stopper 7f provided in case 7. Thus, plunger 15a is constructed not to come out of the coil of solenoid 15 and to stop at a set position.

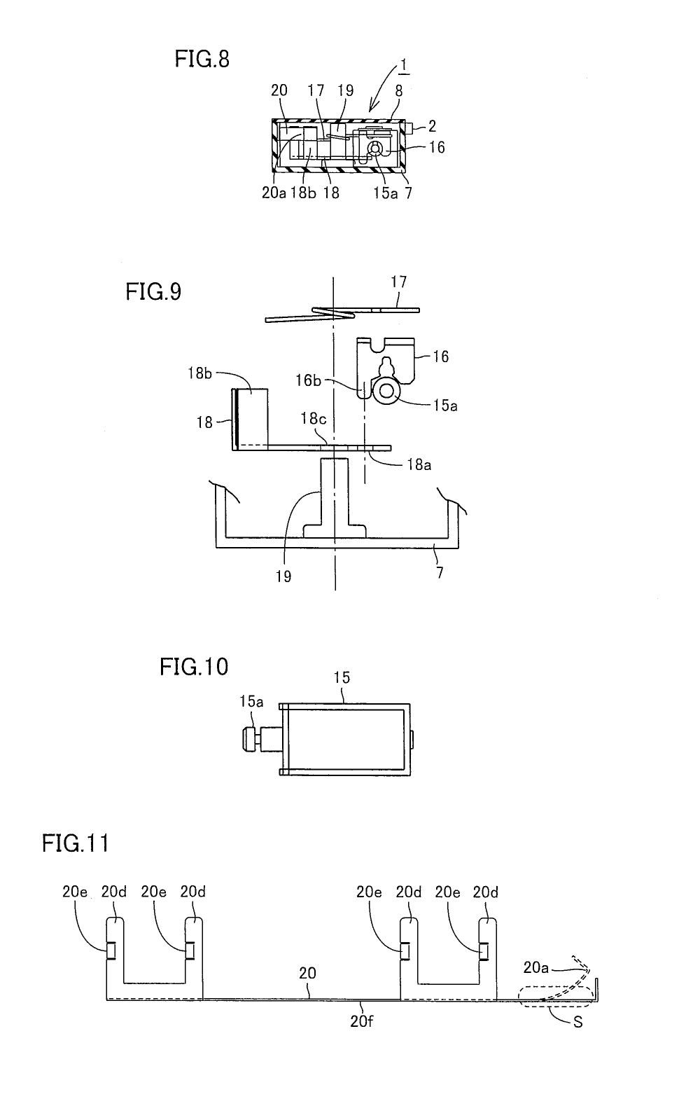

Referring mainly to FIGS. 8 and 9, arm 18 has a through hole 18c for rotation shaft insertion in its central portion, and it is rotatable around rotation shaft 19 as rotation shaft 19 is fitted into through hole 18c. Arm 18 has a coupling hole 18a on one side with respect to rotation shaft 19 and has a slider fixing portion 18b on the other side of rotation shaft 19. A pin portion 16b of coupling plate 16 is fitted into coupling hole 18a in arm 18. An arm attachment portion 20a located at one end of slider 20 is attached to slider fixing portion 18b of arm 18.

A construction of slider 20 will now be described with reference to FIGS. 11 to 16.

Referring to FIGS. 11 to 14, slider 20 is constructed to be able to carry out sliding motion (movement) between a state of being in contact with the discharge electrode and a non-contact state of being not in contact therewith, and is made of a material in a thin plate shape (for example, a thin metal plate). Since corrosion resistance and spring characteristic to some extent are generally required, for example, a stainless plate is optimal for a material for this thin metal plate, however, a phosphor bronze plate or the like may be employed. Slider 20 has a main body portion 20f, arm attachment portion 20a, cut-out portions (through holes) 20b and 20c, a cleaning portion support arm 20d, and a cleaning portion 20e.

Main body portion 20f extends in an elongated manner in a direction of slide. Arm attachment portion 20a is provided at one end of that main body portion 20f extending in an elongated manner. This arm attachment portion 20a is bent at approximately 90° with respect to main body portion 20f for reliable positioning, and it is fixed to slider fixing portion 18b of arm 18 at this bent portion. Various fixing methods are available and for example, screwing, adhesion, welding, clamping, and the like are available.

As shown in FIG. 11, main body portion 20f has a bending portion S for converting rotational motion into sliding motion (linear motion) during a sliding operation. This bending portion S is a portion that is flexed when rotational motion is converted into linear motion, and therefore resistance against rotation is caused unless bending portion S has flexibility to some extent. Then, cut-out portion (through hole) 20b is provided in a necessary portion in bending portion S, so as to adjust flexibility of bending portion S. It is noted that, if bending portion S is too flexible, bending portion S may yield under resistance and flexed at the time of sliding and pushing out, and proper linear motion may not be achieved.

Main body portion 20f may have cut-out portion (through hole) 20c for mitigating increase in resistance due to contact between slider 20 and case 7.

Cleaning portion support arm 20d is bent substantially at a right angle (approximately 90°) with respect to main body portion 20f. Cleaning portion 20e is constructed integrally with slider 20 and it is in such a shape as being cut and raised from a part of cleaning portion support arm 20d at a certain angle.

Cleaning portion support arm 20d and cleaning portion 20e as many as discharge electrodes 3a to 3d are provided. Namely, in the present embodiment, four cleaning portion support arms 20d and four cleaning portions 20e are provided in correspondence with four discharge electrodes 3a to 3d, respectively. These cleaning portions 20e are constructed to be in contact with the respective tip ends of discharge electrodes 3a to 3d when slider 20 slides.

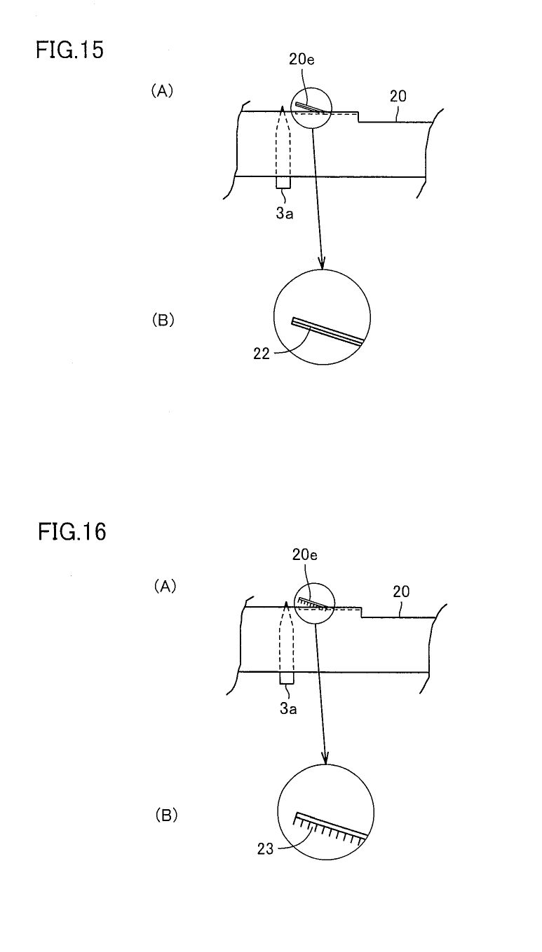

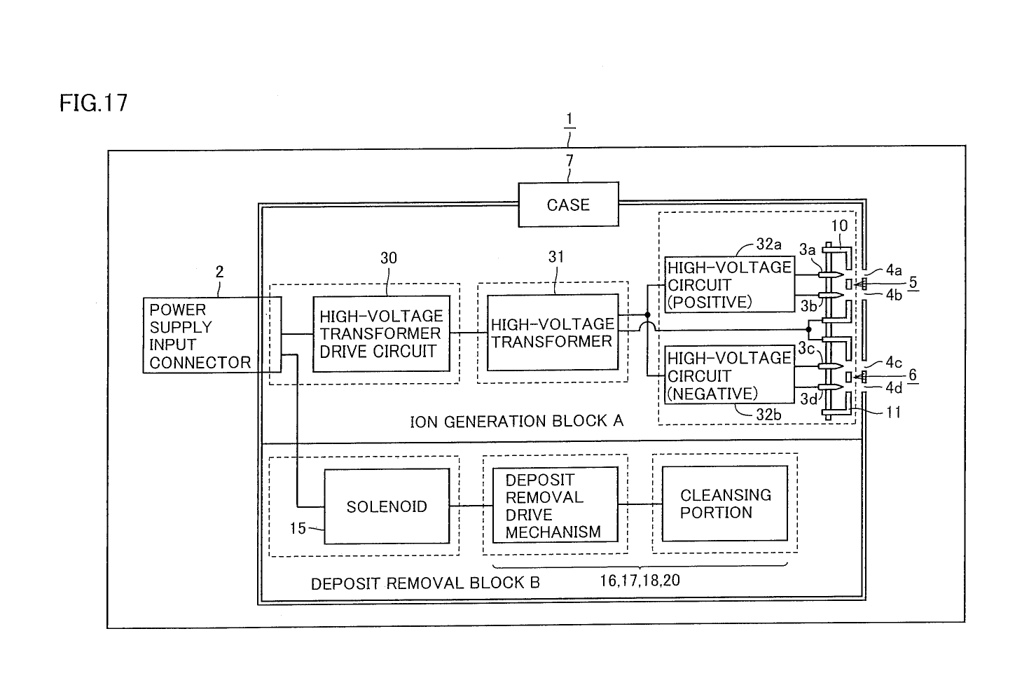

For example as shown in FIGS. 15(A) and (B), cleaning portion 20e may have such a construction that a thin plate made of resin 22 is bonded to slider 20, or such a construction that a brush made of resin 23 is planted in a brush portion base member and then bonded to slider 20 as shown in FIGS. 16(A) and (B).

As shown in FIG. 7, by holding slider 20 with a slider holding portion 7c provided in case 7, positioning of slider 20 in a horizontal direction in the drawing (in particular, holding of a position such that slider 20 is not displaced to the right in the drawing) is carried out. A position of slider 20 in a direction of height is held by sandwiching slider 20 between the surface of opposing electrode 10, 11 and a protrusion 7d.

A functional block of the ion generation apparatus will now be described with reference to FIG. 17.

Referring to FIG. 17, as described above, in ion generation apparatus 1, power supply input connector 2, ion generation elements 5 and 6, substrate 12, and circuit unit 13 (a high-voltage transformer drive circuit 30, a high-voltage transformer 31, and high-voltage circuits 32a and 32b) are mainly arranged in an ion generation element block portion A in case 7. In addition, in deposit removal block B in case 7, deposit removal mechanism portion 21 (solenoid 15, coupling plate 16, spring 17, arm 18, and slider 20) is arranged.

Power supply input connector 2 is a portion receiving DC power supply or commercial AC power supply serving as an input power supply. Power supply input connector 2 is electrically connected to high-voltage transformer drive circuit 30. This high-voltage transformer drive circuit 30 is electrically connected to a primary side of high-voltage transformer 31. This high-voltage transformer 31 serves to boost a voltage input to the primary side for output to a secondary side. One on the secondary side of high-voltage transformer 31 is electrically connected to opposing electrodes 10 and 11 of ion generation elements 5 and 6. The other on the secondary side is electrically connected to discharge electrodes 3a and 3b through high-voltage circuit (positive) 32a and electrically connected to discharge electrodes 3c and 3d through high-voltage circuit (negative) 32b.

In addition, power supply input connector 2 is a portion providing power supply to deposit removal mechanism portion 21. Specifically, power supply input connector 2 provides power supply to solenoid 15. When power supply is provided to solenoid 15, plunger 15a of solenoid 15 operates on the coil. As this plunger 15a operates, a deposit removal drive mechanism portion (coupling plate 16, spring 17, arm 18, and slider 20) operates and cleaning portion 20e which is a brush portion operates, to thereby remove deposits on discharge electrodes 3a to 3d.

As described above, though power supply is provided to the ion generation portion and the deposit removal drive mechanism portion through the same power supply input connector 2, supply systems are independent of each other and hence they can separately be controlled. If cleaning portion 20e comes close to and in contact with the discharge electrode during an operation for removing deposits, unnecessary abnormal discharge may occur. Therefore, power feed to the discharge electrode is desirably stopped during the operation for removing deposits.

Molding will now be described.

Each functional element is molded as appropriate while it is accommodated in case 7 and electrically connected as above. Here, since high-voltage circuits 32a and 32b, a circuit from high-voltage circuits 32a and 32b to discharge electrodes 3a to 3d, or a circuit from high-voltage transformer 31 to opposing electrodes 10 and 11 is a high-voltage portion, insulation is desirably reinforced by molding with resin (for example, epoxy resin) of the back surface side of support substrate 12 except for an ion generation portion (the front surface side of support substrate 12).

A cleaning operation in the ion generation apparatus in the present embodiment will now be described with reference to FIGS. 4 and 18 to 20.

This cleaning operation is performed in the order of (1) to (3) below.

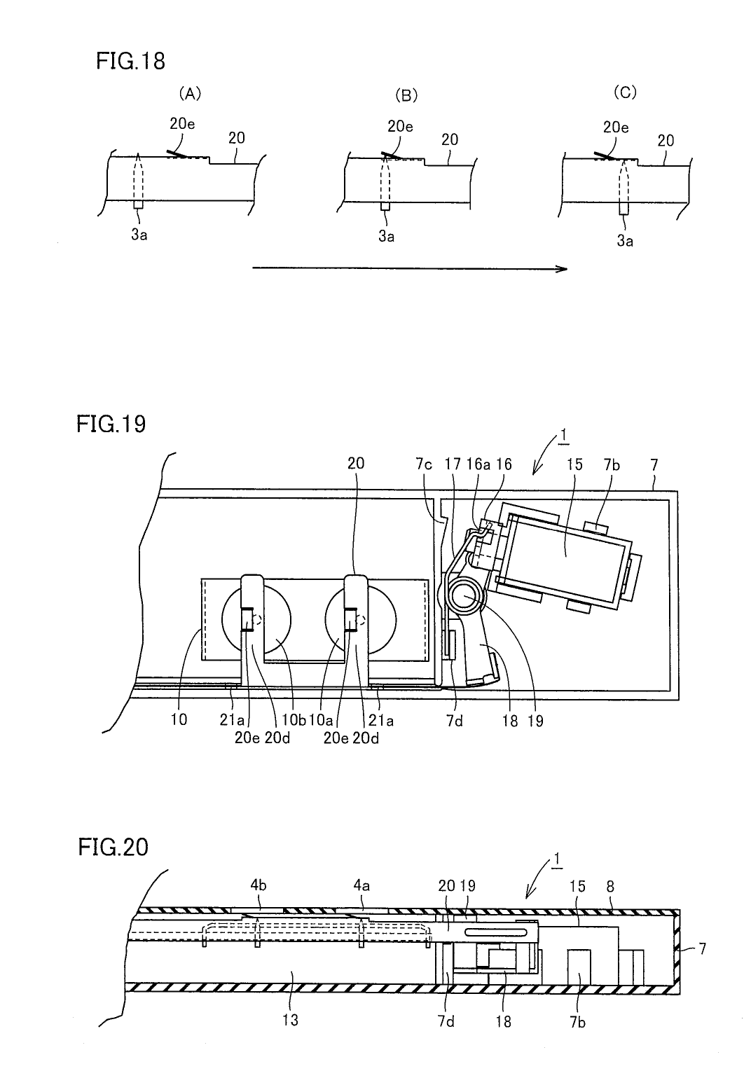

(1) Initially, before the cleaning operation is started, solenoid 15 is in a non-power-fed state. In this state, as shown in FIGS. 4 and 18(A), cleaning portion support arm 20d is located at a position completely away from a tip end portion of each of discharge electrodes 3a to 3d.

(2) As power is fed to solenoid 15, plunger 15a in FIG. 4 is pulled into the coil of solenoid 15. Thus, coupling plate 16 moves and pin portion 16b pulls coupling hole 18a in arm 18, to thereby cause clockwise rotation of arm 18. Since slider 20 is secured to the other end 18b of arm 18 (a portion shown as enlarged in FIG. 5), slider 20 is pushed out as rotating clockwise as arm 18 rotates. Slider 20 carries out sliding motion to the left in the drawing as bending portion S thereof converts rotational motion into linear motion.

As a result of sliding motion of this slider 20, cleaning portion support arm 20d and cleaning portion 20e of slider 20 move to the left in the drawing. FIG. 18(B) shows a state in which this slider 20 is moving. In this state, since an extreme tip end portion of cleaning portion 20e (the tip end portion highest with respect to cleaning portion support arm 20d) is located above the needle-like tip end of each of discharge electrodes 3a to 3d, the tip end of each of discharge electrodes 3a to 3d does not come in contact with the extreme tip end portion of cleaning portion 20e but comes in contact with an intermediate point and further of cleaning portion 20e.

Since thin plate made of resin 22 for cleaning or brush made of resin 23 is bonded to the surface of cleaning portion 20e opposed to discharge electrodes 3a to 3d as described above, respective tip ends of discharge electrodes 3a to 3d come in contact with thin plate made of resin 22 for cleaning or brush made of resin 23 and have contaminants removed, and they are thus cleaned.

(3) FIGS. 18(C), 19 and 20 each show a state in which movement of slider 20 has been completed as a result of power feed to solenoid 15. Sliding motion of slider 20 is completed in such a state that the tip end portion of each of discharge electrodes 3a to 3d passes an inclined portion of cleaning portion 20e and comes in contact with cleaning portion support arm 20d.

As described above, as cleaning portion 20e is brought in contact with and rubs against the needle-like tip end portion of each of discharge electrodes 3a to 3d in coordination with movement of slider 20, deposits on the tip end portion of each of discharge electrodes 3a to 3d can be rubbed off. In addition, shock vibration caused by contact between the tip end portion of each of discharge electrodes 3a to 3d and cleaning portion 20e also allows deposits on a peripheral portion to peel off

As power feed to solenoid 15 is turned OFF, plunger 15a is pulled by biasing force of spring 17 in a direction pulling plunger 15a out of the coil of solenoid 15. As thus arm 18 rotates counterclockwise in FIG. 19, slider 20 carries out sliding motion to the right in the drawing and returns to the state in FIG. 4.

Such a cleaning operation does not have to frequently be performed in a general residential space, and for example, a cleaning operation even once a month will suffice. Deposits can be removed to prevent lowering in an amount of ion generation, for example, automatically every predetermined operation time, in coordination with power feed ON-OFF of ion generation apparatus 1, or when an amount of generated ions is detected by an ion amount sensor and the amount is equal to or lower than a predetermined amount.

When plate-shaped opposing electrodes 10 and 11 and needle-like discharge electrodes 3a to 3d are arranged in ion generation elements 5 and 6 above with a prescribed distance as above being ensured and then a high voltage is applied across opposing electrodes 10 and 11 and discharge electrodes 3a to 3d, corona discharge is caused at the tip end of each of needle-like discharge electrodes 3a to 3d. This corona discharge causes generation of at least any of positive ions and negative ions, and these ions are emitted to the outside through through holes 4a to 4d provided in a main body of ion generation apparatus 1. Further by blowing, ions can more effectively be emitted.

In generating both of positive ions and negative ions, positive ions are generated by causing positive corona discharge at the tip ends of one discharge electrodes 3a and 3b, while negative ions are generated by causing negative corona discharge at the tip ends of the other discharge electrodes 3c and 3d. A waveform to be applied does not particularly matter here, and a high voltage such as a direct current, an alternating current waveform biased positively or negatively, or a pulse waveform biased positively or negatively is employed. As a voltage value, a voltage region sufficient for causing discharge and causing generation of prescribed ion species is selected.

Here, positive ions are such cluster ions that a plurality of water molecules are attached around hydrogen ion (H⁺) and expressed as H⁺(H₂O)ₘ (m being 0 or any natural number). Meanwhile, negative ions are such cluster ions that a plurality of water molecules are attached around oxygen ion (O₂⁻) and expressed as O₂⁻(H₂O)ₙ (n being 0 or any natural number).

In emitting ions of both polarities of positive ions and negative ions, by generating substantially the same amounts of positive ions in air, that is, H⁺(H₂O)ₘ (m being 0 or any natural number), and negative ions, that is, O₂⁻(H₂O)ₙ (n being 0 or any natural number), both ions surround mold fungi or viruses floating in the air, and as a result of action of hydroxyl radicals (—OH) which are active species generated at that time, airborne mold fungi and the like can be removed.

A function and effect of the ion generation apparatus in the present embodiment will now be described.

According to ion generation apparatus 1 in the present embodiment, slider 20 can move between the state of being in contact with discharge electrodes 3a to 3d (the contact state) and the state of not being in contact therewith (the non-contact state) as a result of sliding motion. Therefore, during cleaning of discharge electrodes 3a to 3d, by bringing cleaning portion 20e of slider 20 into contact with each of discharge electrodes 3a to 3d, discharge electrodes 3a to 3d can be cleaned. In addition, by preventing slider 20 from coming in contact with discharge electrodes 3a to 3d during discharge by discharge electrodes 3a to 3d, slider 20 can be prevented also from impeding discharge. Thus, since contamination of discharge electrodes 3a to 3d can be removed with slider 20 and slider 20 does not impede discharge either, lowering in ion generation efficiency can be prevented even in an environment where there is much dust.

In addition, since slider 20 has bending portion S for converting rotational motion into sliding motion (linear motion), large linear motion can be obtained from small linear motion through rotational motion.

Specifically, a distance from a rotation center of arm 18 to a position of attachment of slider 20 to arm 18 is made greater than a distance from the rotation center of arm 18 to a position of attachment of plunger 15a to arm 18, so that a distance of travel can be increased based on the principle of leverage. Namely, since a distance of travel of plunger 15a in general solenoid 15 is as small as about 5 mm, it is difficult to achieve sliding movement of slider 20 by a distance necessary for the cleaning operation. By once converting the distance of travel of plunger 15a into rotational motion, however, sliding movement, for example, twice as large as the former, that is, approximately 10 mm, can be achieved.

It is noted that a special solenoid long in a distance of drive may be used to directly drive slider 20 (that is, to directly carry out sliding motion of slider 20 without converting linear motion of plunger 15a into rotational motion).

In addition, since slider 20 is made of a thin metal plate, bending portion S for converting rotational motion into sliding motion can be implemented with a simplified construction and reduction in size of slider 20 is facilitated.

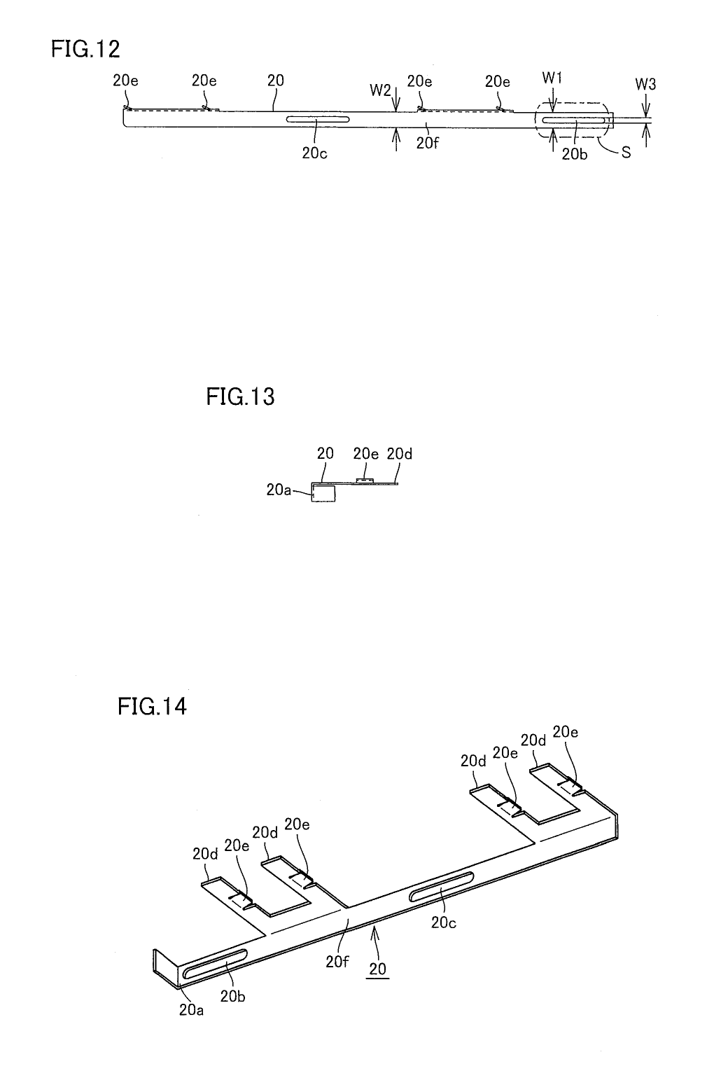

Moreover, bending portion S of slider 20 is smaller in dimension in a direction of width than a portion other than bending portion S of slider 20. Specifically, referring to FIG. 12, bending portion S of slider 20 has cut-out portion 20b so that a substantial dimension of bending portion S in the direction of width is set to (W1-W3), which is smaller than a dimension W2 (substantially the same in dimension as W1) of a portion other than bending portion S. Flexibility of bending portion S is thus adjusted and resistance caused when bending portion S converts rotational motion into sliding motion is decreased. Thus, bending portion S can be implemented with a simplified construction.

Further, since ion generation apparatus 1 is configured to stop power feed to discharge electrodes 3a to 3d while slider 20 is in contact with discharge electrodes 3a to 3d, slider 20 can be prevented from impeding discharge while discharge electrodes 3a to 3d are discharging.

### Second Embodiment

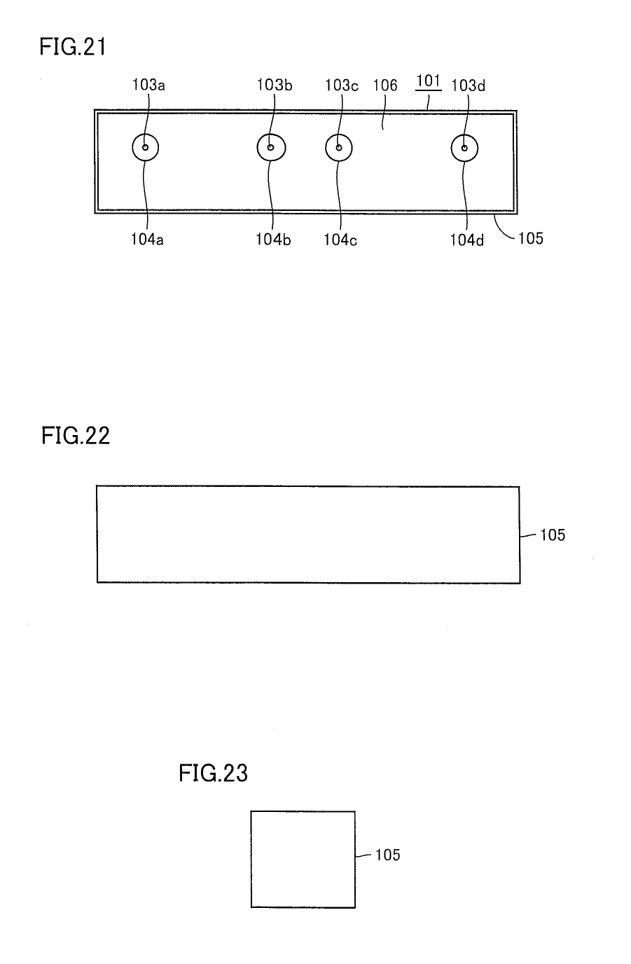

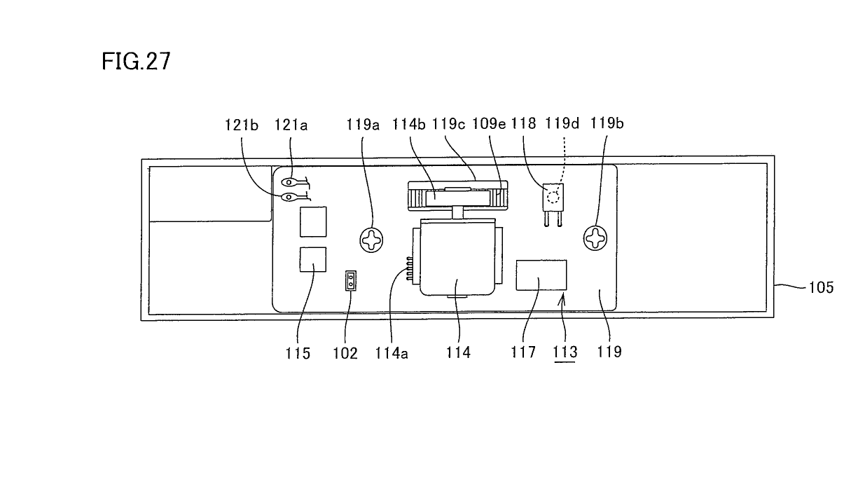

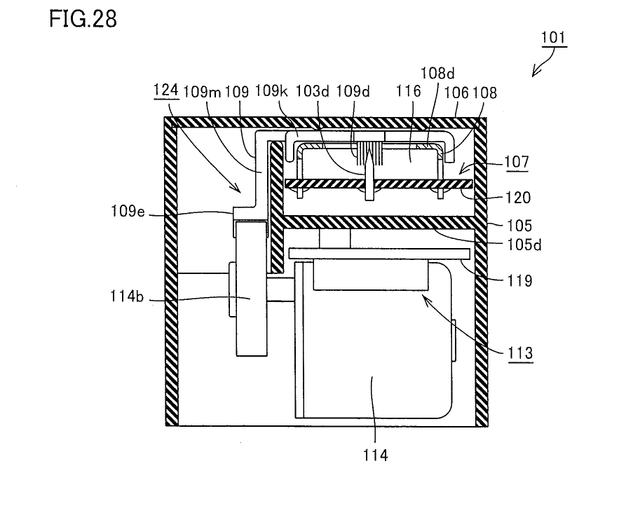

An overall construction of an ion generation apparatus in a second embodiment of the present invention will now be described with reference to FIGS. 21 to 28 and 39.

Referring to FIGS. 21 to 28, an ion generation apparatus 101 in the second embodiment of the present invention mainly has a power supply input connector 102, a case 105, a cover 106, an ion generation circuit portion 107, a motor control circuit portion 113, and a deposit removal portion 124.

Referring to FIGS. 21 to 23, case 105 and cover 106 constitute an outer shell of ion generation apparatus 101. In cover 106, a plurality of (for example, four) through holes 104a to 104d are formed. These through holes 104a to 104d are opening portions for emitting ions generated through corona discharge to the outside of case 105.

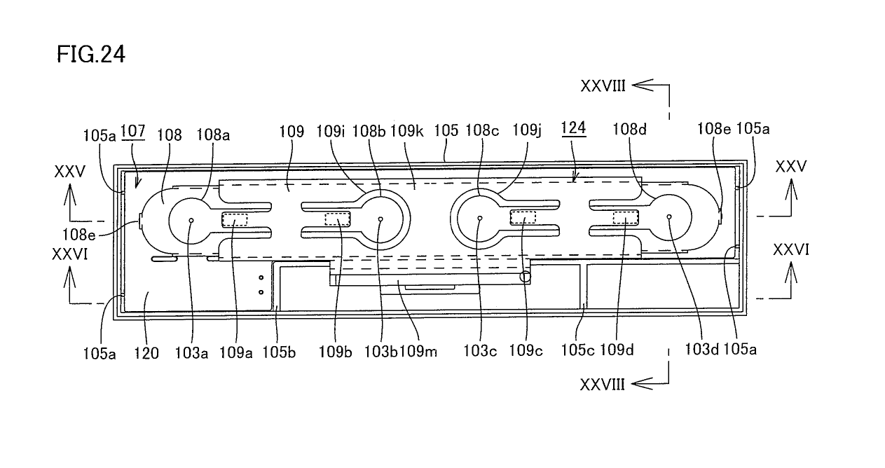

Referring to FIGS. 24 to 27, power supply input connector 102, ion generation circuit portion 107, motor control circuit portion 113, and deposit removal portion 124 are accommodated in case 105.

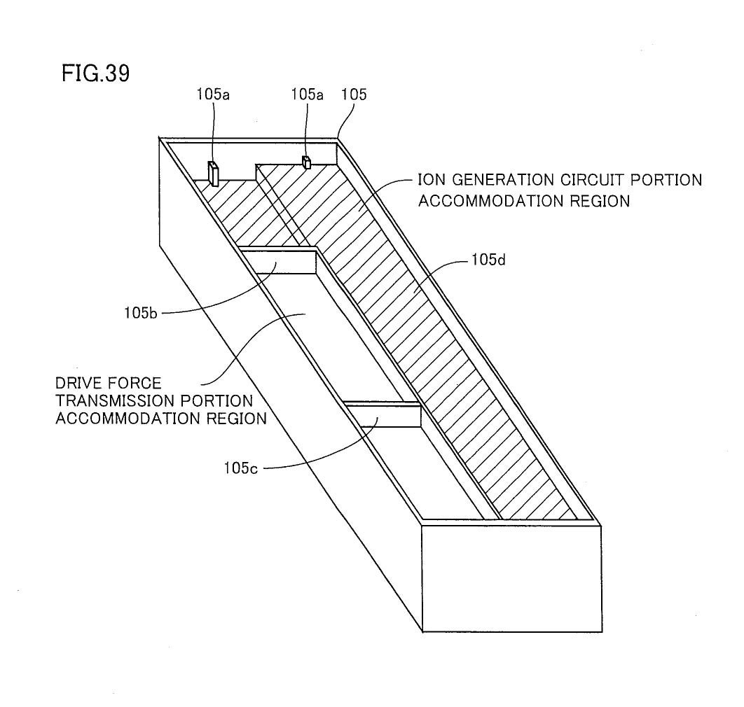

Referring to FIG. 39, this case 105 is divided into two stages, i.e., upper and lower stages, by an interior plate 105d. The upper stage side of case 105 divided by interior plate 105d is two-dimensionally partitioned into an ion generation circuit portion accommodation region (a portion with diagonally right up hatch) and a drive force transmission portion accommodation region by stopper portions (wall portions) 105b and 105c.

Referring to FIGS. 24 to 27, ion generation circuit portion 107 is arranged in the above-described ion generation circuit portion accommodation region in case 105. Motor control circuit portion 113 is arranged in a region on the lower stage side of case 105 divided by interior plate 105d. Deposit removal portion 124 is arranged across a region on the lower stage side of case 105, the drive force transmission portion accommodation region, and the ion generation circuit portion accommodation region.

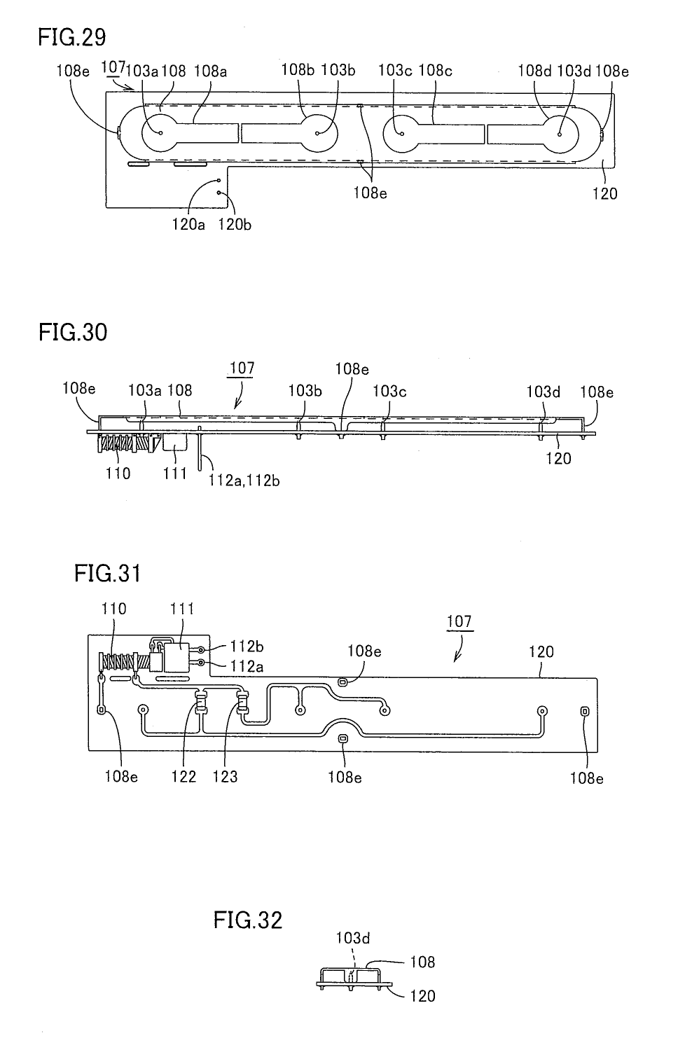

A construction of ion generation circuit portion 107 above will now be described with reference to FIGS. 29 to 32.

Referring to FIGS. 29 to 32, ion generation circuit portion 107 mainly has a support substrate 120, ion generation portions 103a to 103d and 108, high-voltage circuits (high-voltage diodes) 122 and 123, a high-voltage transformer 110, and a high-voltage transformer drive circuit 111. Ion generation portions 103a to 103d and 108 serve to generate at least any of positive ions and negative ions, for example, through corona discharge, and they have a plurality of discharge electrodes 103a to 103d and an opposing electrode (induction electrode) 108.

Opposing electrode 108 is supported by support substrate 120. Opposing electrode 108 is made of a one-piece metal plate and it has a plurality of through holes 108a to 108d provided in a top plate portion in number as many as the number of discharge electrodes 103a to 103d. Ions are generated by causing corona discharge between a circular end surface portion of each of these through holes 108a to 108d and discharge electrodes 103a to 103d. Each of these through holes 108a to 108d is an opening portion for emitting ions generated through corona discharge to the outside of case 105.

In the present embodiment, the number of through holes 108a to 108d is set, for example, to four, and each of through holes 108a to 108d has a two-dimensional shape, for example, like a keyhole formed by combining a circular portion and a quadrangular portion (rectangular portion).

Each of discharge electrodes 103a to 103d has a needle-like tip end. Support substrate 120 has a through hole (not shown) for insertion of each of discharge electrodes 103a to 103d and a through hole (not shown) for insertion of an attachment leg 108e of opposing electrode 108.

Each of needle-like discharge electrodes 103a to 103d is supported as it is inserted or press-fitted into the through hole in support substrate 120 to penetrate support substrate 120. Thus, needle-like one end of each of discharge electrodes 103a to 103d protrudes on a front surface side of support substrate 120, and the other end protruding on a back surface side of support substrate 120 is electrically connected to an interconnection pattern on the back surface of support substrate 120 by soldering.

In addition, opposing electrode 108 is supported as attachment leg 108e is inserted or press-fitted into the through hole in support substrate 120 to penetrate support substrate 120. Further, this attachment leg 108e is electrically connected at a protruding end portion on the back surface side of support substrate 120 to an interconnection pattern on the back surface of support substrate 120 by soldering.

While opposing electrode 108 and discharge electrodes 103a to 103d are attached to support substrate 120, each of discharge electrodes 103a to 103d is arranged such that its needle-like tip end is located in the center of the circular portion of each of ion emission holes 108a to 108d of opposing electrode 108 as shown in FIG. 29. In addition, on the back surface (soldering surface) of support substrate 120, such constituent elements as high-voltage transformer 110, high-voltage transformer drive circuit 111, and high-voltage diodes 122 and 123 are attached.

In addition, through holes 120a and 120b are provided in support substrate 120, and lead pins 112a and 112b pass through through holes 120a and 120b respectively and are supported by support substrate 120. Each of these lead pins 112a and 112b is electrically connected to high-voltage transformer drive circuit 111 through the interconnection pattern on the back surface of support substrate 120.

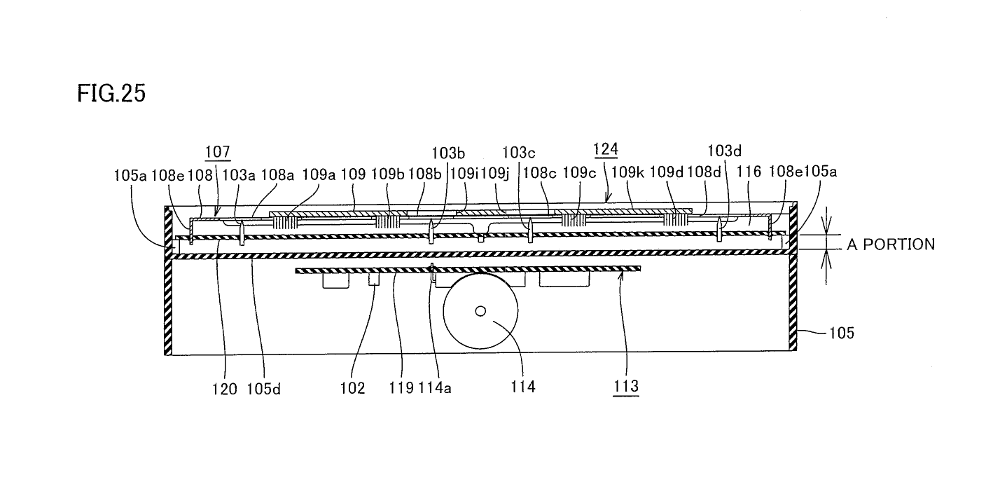

Support substrate 120 is arranged in the above-described ion generation circuit portion accommodation region in case 105 while it supports opposing electrode 108 and discharge electrodes 103a to 103d as shown in FIGS. 24 and 25. Here, support substrate 120 is positioned at a defined height by a substrate holding wall 105a. In addition, opposing electrode 108 is positioned at a defined height with respect to the surface of support substrate 120 as shown in FIG. 32. As thus support substrate 120 and opposing electrode 108 are each positioned at a defined height, opposing electrode 108 can be positioned with respect to support substrate 120 in a direction of its thickness.

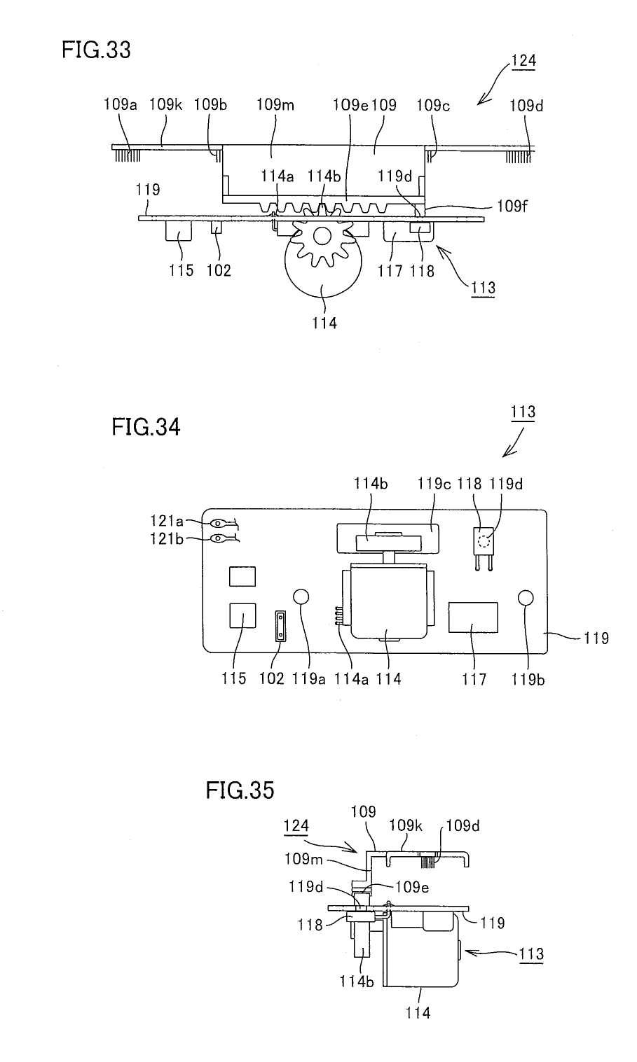

A construction of motor control circuit portion 113 and a construction of deposit removal portion 124 above will now be described with reference to FIGS. 33 to 35.

Referring to FIGS. 33 to 35, motor control circuit portion 113 mainly has a motor 114, a motor control circuit 115, a cleaning slider position detection circuit 117, a position detection element 118, and a substrate 119. These motor 114, motor control circuit 115, cleaning slider position detection circuit 117, and position detection element 118 are attached on a back surface side of substrate 119. In addition, connection pin attachment portions 121a and 121b and power supply input connector 102 are also attached to substrate 119.

Motor 114 is electrically connected to a circuit of substrate 119 through a motor terminal 114a. Position detection element 118 serves to detect reflection of infrared rays and detect whether a moving element is present or not, for example, like a reflective photointerrupter.

In substrate 119, substrate attachment holes 119a and 119b for passage of a screw or the like, a hole 119c for passage of a pinion gear 114b attached to motor 114, a position detection hole 119d for passage of light (for example, infrared rays) emitted from position detection element 118 are formed.

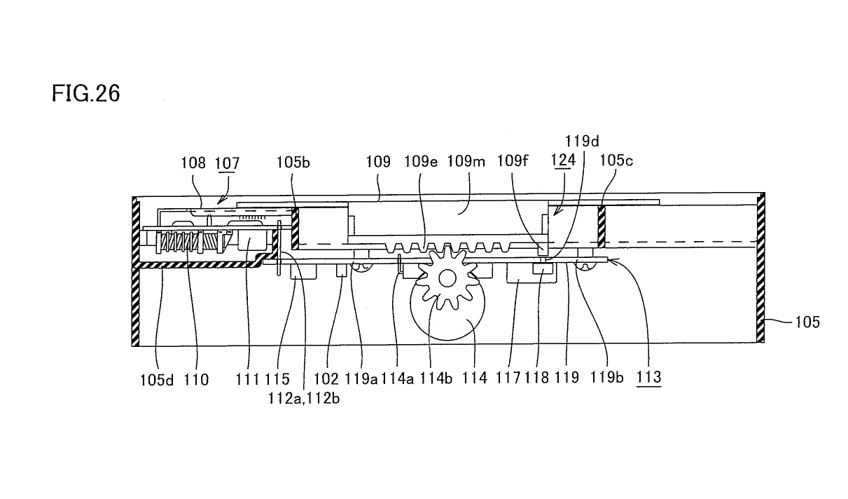

While substrate 119 supports motor 114 and the like, substrate 119 is arranged on the lower stage side of case 105 as shown in FIGS. 25 and 26. This substrate 119 is fixed to case 105 by screwing a screw or the like into case 105 through substrate attachment holes 119a and 119b. While substrate 119 is fixed to case 105, connection pin attachment portions 121a and 121b are electrically connected to lead pins 112a and 112b, respectively. Thus, a part of power supply that is input through power supply input connector 102 can be supplied from connection pin attachment portions 121a and 121b through lead pins 112a and 112b to ion generation circuit portion 107.

Referring to FIGS. 33 to 35, deposit removal portion 124 mainly has pinion gear 114b and a cleaning slider (cleaning member) 109. Pinion gear 114b is attached to motor 114 and it is rotatable by torque of motor 114. Cleaning slider 109 mainly has a rack gear 109e engaged with this pinion gear 114b, cleaning portions 109a to 109d for cleaning discharge electrodes 103a to 103d, and a position detection portion 109f.

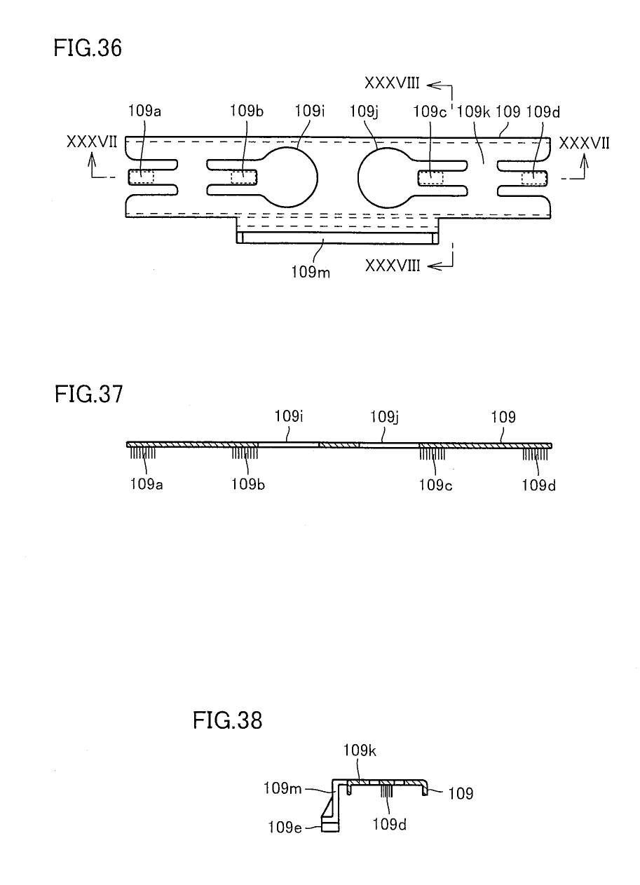

A construction of cleaning slider 109 will now be described with reference to FIGS. 36 to 38.

Referring to FIGS. 36 to 38, cleaning slider 109 has a top plate portion 109k and a side plate portion 109m extending downward from a side portion of that top plate portion 109k. Top plate portion 109k has through holes 109i and 109j in a keyhole shape formed by combining a circular portion and a rectangular portion. An extension portion extends from an end portion of the rectangular portion toward the circular portion of each of these through holes 109i and 109j and each of cleaning portions 109b and 109c is attached to a tip end of that extension portion. In addition, a rectangular notch portion is provided in each of opposing end portions of top plate portion 109k. An extension portion extends outward from the notch portion to the end portion and each of cleaning portions 109a and 109d is attached to a tip end of the extension portion.

These cleaning portions 109a to 109d are made of a brush having flexibility to some extent (a cleaning member similar to a toothbrush). A brush making up cleaning portions 109a to 109d extends downward from a bottom surface of top plate portion 109k of cleaning slider 109. Rack gear 109e is formed at a lower end of side plate portion 109m of cleaning slider 109. In a portion at the lower end of side plate portion 109m of cleaning slider 109 where rack gear 109e is not formed, position detection portion 109f is provided as shown in FIG. 33.

As shown in FIGS. 24 to 26, cleaning slider 109 is arranged such that its top plate portion 109k is located in the above-described ion generation circuit portion accommodation region and side plate portion 109m is located in the above-described drive force transmission portion accommodation region of case 105. In such a state of arrangement, top plate portion 109k is arranged such that it is located above the top plate portion of opposing electrode 108 and it extends across above the top plate portion of opposing electrode 108. In this state, cleaning portions 109a to 109d of cleaning slider 109 are located to be inserted into through holes 108a to 108d in a keyhole shape in opposing electrode 108, respectively.

In addition, a plurality of discharge electrodes 103a to 103d are aligned on a straight line when viewed two-dimensionally, and cleaning portions 109a to 109d are also arranged on the same straight line.

In the state of arrangement above, as shown in FIG. 26, rack gear 109e at the lower end of side plate portion 109m is engaged with pinion gear 114b in the above-described drive force transmission portion accommodation region of case 105. Thus, rotational motion of motor 114 can be converted into linear motion of cleaning slider 109. A direction of linear motion of cleaning slider 109 is the same as a direction of the straight line on which the plurality of discharge electrodes 103a to 103d are aligned when viewed two-dimensionally. As a result of reciprocating motion of this cleaning slider 109 in the direction of the straight line, cleaning portions 109a to 109d can be brought in contact with discharge electrodes 103a to 103d respectively and thus discharge electrodes 103a to 103d can be cleaned.

In the state of arrangement above, as shown in FIG. 26, position detection portion 109f can face position detection element 118 through position detection hole 119d. Infrared rays emitted from position detection element 118 pass through position detection hole 119d and reach cleaning slider 109. Here, only when position detection portion 109f of cleaning slider 109 faces position detection element 118, infrared rays are reflected and a position of cleaning slider 109 can be detected.

A position of cleaning slider 109 which carries out linear motion can be detected as above. A technique for detecting a position of cleaning slider 109 is not limited as above, and for example, a detection technique utilizing a macro switch, a technique utilizing a magnet and a reed switch, and the like are also applicable.

Referring to FIGS. 25 and 26, power supply input connector 102 is provided on a rear surface side of ion generation apparatus 101 for electrical connection to the outside of case 105.

Referring to FIG. 21, cover 106 of case 105 has through holes 104a to 104d for ion emission in a wall portion opposed to through holes 108a to 108d in opposing electrode 108. Thus, ions generated by ion generation circuit portion 107 are emitted to the outside of ion generation apparatus 101 through these through holes 104a to 104d. Discharge electrodes 103a and 103d of ion generation circuit portion 107 serve, for example, to generate positive ions, while discharge electrodes 103b and 103c of ion generation circuit portion 107 serve, for example, to generate negative ions. Therefore, one through holes 104a and 104d provided in cover 106 serve as a positive ion generation portion, and the other through holes 104b and 104c serve as a negative ion generation portion.

For preventing electric shock, each of through holes 104a to 104d for ion emission is set to have a diameter smaller than a diameter of each of through holes 108a to 108d in opposing electrode 108 such that a hand is not in direct contact with opposing electrode 108 which is a power feed portion.

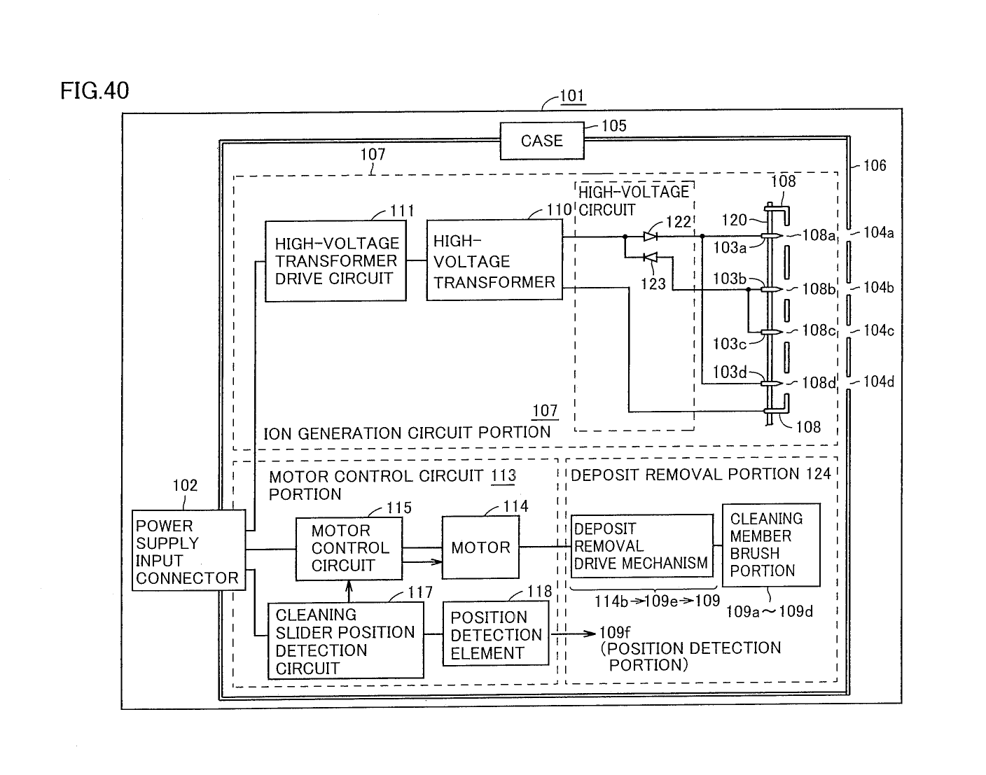

A functional block of the ion generation apparatus will now be described with reference to FIG. 40.

Referring to FIG. 40, as described above, in ion generation apparatus 101, power supply input connector 102, ion generation circuit portion 107, motor control circuit portion 113, and deposit removal portion 124 are mainly arranged in case 105.

Power supply input connector 102 is a portion receiving DC power supply or commercial AC power supply serving as input power supply. Power supply input connector 102 is electrically connected to high-voltage transformer drive circuit 111. This high-voltage transformer drive circuit 111 is electrically connected to a primary side of high-voltage transformer 110. This high-voltage transformer 110 serves to boost a voltage input to the primary side for output to a secondary side. One on the secondary side of high-voltage transformer 110 is electrically connected to opposing electrode 108. The other on the secondary side of high-voltage transformer 110 is electrically connected to discharge electrodes 103a and 103d through high-voltage diode 122 and electrically connected to discharge electrodes 103b and 103c through high-voltage diode 123.

In addition, power supply input connector 102 is a portion providing power supply to motor control circuit portion 113. Specifically, power supply input connector 102 provides power supply to motor 114 through motor control circuit 115 and provides power supply to cleaning slider position detection circuit 117 detecting a position of cleaning slider 109. When power supply is provided to motor 114, pinion gear 114b, rack gear 109e and cleaning slider 109 operate and cleaning portions 109a to 109d clean discharge electrodes 103a to 103d. Thus, deposits on discharge electrodes 103a to 103d are removed.

As power supply is provided to cleaning slider position detection circuit 117 and position detection element 118, a position of cleaning slider 109 can be detected based on whether infrared rays emitted from position detection element 118 are reflected by position detection portion 109f of cleaning slider 109 or not.

As described above, though power supply is provided to ion generation circuit portion 107 and motor control circuit portion 113 through the same power supply input connector 102, supply systems are independent of each other and they can separately be controlled. In addition, this ion generation apparatus 101 can be incorporated in various types of electric equipment so as to allow control of the entirety by the electric equipment. Therefore, control in conformity with each type of electric equipment can be carried out. If cleaning portions 109a to 109d come close to and in contact with discharge electrodes 103a to 103d during an operation for removing deposits, unnecessary abnormal discharge may occur. Therefore, power feed to discharge electrodes 103a to 103d is desirably stopped during the operation for removing deposits.

Molding will now be described.

Each functional element is molded as appropriate while it is accommodated in case 105 and electrically connected as above. Here, since high-voltage transformer 110, high-voltage diodes 122 and 123, a circuit from high-voltage diodes 122 and 123 to discharge electrodes 103a to 103d, a circuit from high-voltage transformer 110 to opposing electrode 108, and discharge electrodes 103a to 103d are high-voltage portions, insulation is desirably reinforced by molding with resin (for example, epoxy resin) of the back surface side of support substrate 120 except for an ion generation portion (a front surface side of support substrate 120).

As shown in FIG. 39, the upper stage side of case 105 above interior plate 105d is two-dimensionally partitioned into the ion generation circuit portion accommodation region (a portion with diagonally right up hatch) and the drive force transmission portion accommodation region by stopper portions 105b and 105c. Therefore, when resin is injected into the ion generation circuit portion accommodation region during resin molding above, the back surface side of support substrate 120 can be resin-molded and the resin can be prevented from flowing from the ion generation circuit portion accommodation region to the drive force transmission portion accommodation region.

A cleaning operation in ion generation apparatus 101 in the present embodiment will now be described with reference to FIGS. 25, 26, 40, and 41.

Referring to FIGS. 25, 26, and 40, initially, when a signal is input to motor control circuit 115 from power supply input connector 102, motor 114 is driven. Thus, pinion gear 114b directly coupled to motor 114 rotates and drive force is transmitted to rack gear 109e engaged with pinion gear 114b, so that cleaning slider 109 starts linear movement to the right or left. Whether the cleaning slider moves to the right or left is determined by a direction of rotation of motor 114. The cleaning operation starts as above.

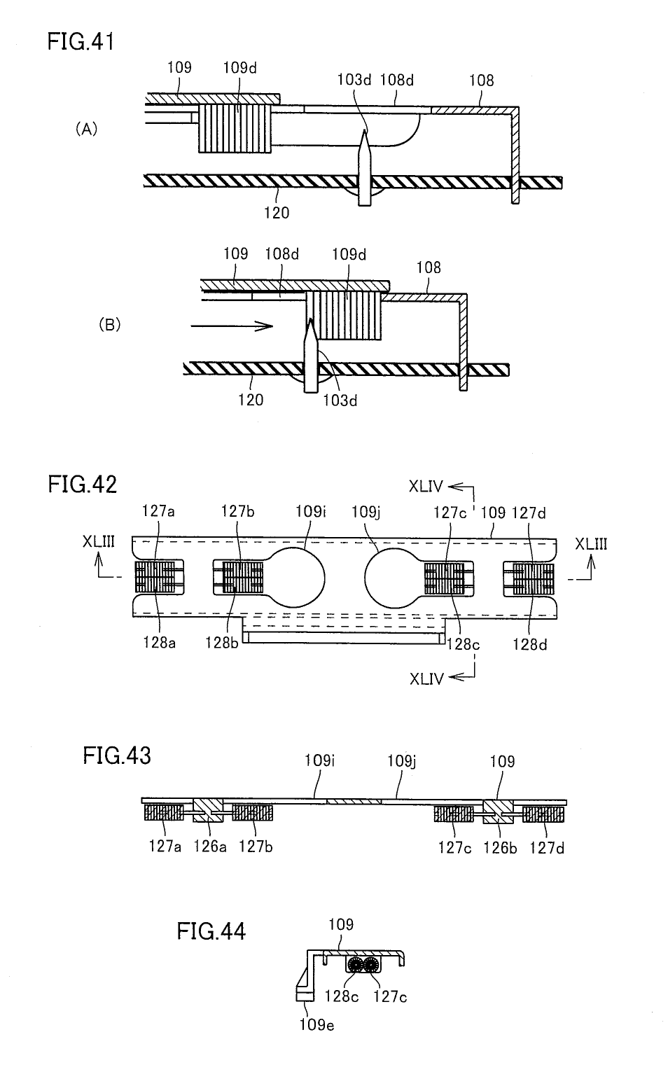

As a result of the operation above, cleaning slider 109 can be moved from a state in which cleaning portions 109a to 109d are not in contact with discharge electrodes 103a to 103d, for example, as shown in FIG. 41(A), to a state in which cleaning portions 109b and 109d are in contact with discharge electrodes 103b and 103d as shown in FIG. 41(B).

A distance of travel of cleaning slider 109 can be controlled based on the number of counts of applied pulses in a case where motor 114 is implemented, for example, by a stepping motor, and alternatively, in a case where motor 114 is implemented, for example, by a simple DC motor, a distance of travel can be controlled by controlling a time period for power feed. Even if cleaning slider 109 goes too far, cleaning slider 9 hits left or right stopper portion 105b or 105c and it cannot move any farther.

When movement as far as a right terminal end, for example, is completed, motor 114 is reversed to move cleaning slider 109 to the left. Thus, cleaning slider 109 can be moved from the state where cleaning portions 109b and 109d are in contact with discharge electrodes 103b and 103d to the state where cleaning portions 109a and 109c are in contact with discharge electrodes 103a and 103c, respectively. Then, when cleaning slider 109 moves to a left terminal end, motor 114 is similarly reversed to move cleaning slider 109 to the right.

Then, when position detection portion 109f provided in cleaning slider 109 comes to a position of position detection hole 119d provided in substrate 119, position detection element 118 detects that fact and sends a position signal to the electric equipment through power supply input connector 102. Detecting that signal, the electric equipment stops a drive signal to motor 114 so that motor 114 stops at that position. Thus, as shown in FIG. 41(A), cleaning portions 109a to 109d can be stopped in a state of not being in contact with discharge electrodes 103a to 103d.

This position (a position shown in FIG. 41(A)) is set as a position of cleaning slider 109 when ions are normally generated.

The cleaning operation above ends as cleaning slider 109 carries out reciprocating motion once and returns to its original position. Thus, discharge electrodes 103a to 103d have been cleaned as they have been rubbed by cleaning portions 109a to 109d for removal of deposits in one reciprocation.

Motor 114 is incorporated in ion generation apparatus 101 in FIGS. 24 to 28. If motor 114 should only drive cleaning slider 109, however, it does not have to be incorporated in ion generation apparatus 101 but it may be arranged outside ion generation apparatus 101. In this case, if a shaft of rack gear 109e is structured to extend to the outside of ion generation apparatus 101 and engage with pinion gear 114b attached to motor 114 in the outside of ion generation apparatus 101, motor 114 can drive cleaning slider 109. In addition, if the electric equipment incorporating ion generation apparatus 101 has some kind of drive source, use of such a drive source to drive cleaning slider 109 will be advantageous in terms of cost.

As described above, as motor 114 rotates to rotate pinion gear 114b and move rack gear 109e to the left and right, cleaning slider 109 linearly moves to the left and right so that cleaning portions 109a to 109d are brought in contact with and rub against the needle-like tip end portions of respective discharge electrodes 103a to 103d. Thus, deposits on the tip end portion of each of discharge electrodes 103a to 103d can be rubbed off.

Such a cleaning operation does not have to frequently be performed in a general residential space, and for example, a cleaning operation even once a month will suffice. Deposits can be removed to prevent lowering in an amount of ion generation, for example, automatically every predetermined operation time, in coordination with power feed ON-OFF of the ion generation apparatus, or when an amount of generated ions is detected by an ion amount sensor and the amount is equal to or lower than a predetermined amount.

When plate-shaped opposing electrode 108 and needle-like discharge electrodes 103a to 103d are arranged in the ion generation portion with a prescribed distance as above being ensured and then a high voltage is applied across opposing electrode 108 and discharge electrodes 103a to 103d, corona discharge is caused at respective tip ends of needle-like discharge electrodes 103a to 103d. This corona discharge causes generation of at least any of positive ions and negative ions, and these ions are emitted to the outside through ion emission holes 104a to 104d provided in a main body of ion generation apparatus 1. Further by blowing, ions can more effectively be emitted.

In generating both of positive ions and negative ions, positive ions are generated by causing positive corona discharge at the tip ends of one discharge electrodes 103a and 103d, while negative ions are generated by causing negative corona discharge at the tip ends of the other discharge electrodes 103b and 103c. A waveform to be applied does not particularly matter here, and a high voltage such as a direct current, an alternating current waveform biased positively or negatively, or a pulse waveform biased positively or negatively is employed. As a voltage value, a voltage region sufficient for causing discharge and causing generation of prescribed ion species is selected.

Here, positive ions are such cluster ions that a plurality of water molecules are attached around hydrogen ion (H⁺) and expressed as H⁺(H₂O)ₘ (m being 0 or any natural number). Meanwhile, negative ions are such cluster ions that a plurality of water molecules are attached around oxygen ion (O₂⁻) and expressed as O₂⁻(H₂O)ₙ (n being 0 or any natural number).

In emitting ions of both polarities of positive ions and negative ions, by generating substantially the same amounts of positive ions in air, that is, H⁺(H₂O)ₘ (m being 0 or any natural number), and negative ions, that is, O₂⁻(H₂O)ₙ (n being 0 or any natural number), both ions surround mold fungi or viruses floating in the air, and as a result of action of hydroxyl radicals (—OH) which are active species generated at that time, airborne mold fungi and the like can be removed.

A function and effect of the ion generation apparatus in the present embodiment will now be described.

According to ion generation apparatus 101 in the present embodiment, cleaning slider 109 can move between the contact state in which cleaning portions 109a to 109d are in contact with discharge electrodes 103a to 103d and the non-contact state in which they are not in contact therewith as shown in FIGS. 41(A) and (B). Therefore, by bringing cleaning portions 109a to 109d into contact with respective discharge electrodes 103a to 103d during cleaning of discharge electrodes 103a to 103d, discharge electrodes 103a to 103d can be cleaned. On the other hand, by preventing cleaning portions 109a to 109d from coming in contact with discharge electrodes 103a to 103d during discharge by discharge electrodes 103a to 103d, cleaning portions 109a to 109d can be prevented also from impeding discharge. Thus, since contamination of discharge electrodes 103a to 103d can be removed with cleaning portions 109a to 109d and cleaning portions 109a to 109d do not impede discharge either, lowering in ion generation efficiency can be prevented even in an environment where there is much dust.

In addition, since motor 114 serves as a drive source for allowing movement of cleaning slider 109, control of a moving speed is easy. Thus, since a time period during which cleaning portions 109a to 109d come in contact with discharge electrodes 103a to 103d can be long, removal of deposits is facilitated. Moreover, as motor 114 serves as the drive source, a distance of travel of cleaning slider 109 can be long, a large area of a portion where cleaning portions 109a to 109d come in contact with discharge electrodes 103a to 103d can be ensured and removal of deposits is facilitated.

Further, rotational motion of motor 114 can be converted into linear motion of cleaning slider 109 by engagement between pinion gear 114b and rack gear 109e.

As described above, according to the present embodiment, a deposit removal apparatus with a simplified construction can remove deposits, either automatically, in a certain prescribed cycle, every predetermined operation time, in coordination with ON-OFF of the ion generation apparatus, or when an amount of generated ions is detected by an ion sensor and the amount is equal to or lower than a predetermined amount, and thus lowering in the amount of ion generation can be prevented.

Therefore, since the amount of ion generation can be maintained throughout the life of the electric equipment incorporating ion generation apparatus 101, the possibility of incorporation thereof in various types of electric equipment is expanded and applications to electric equipment incorporating ion generation apparatus 101 can be expanded.

### Third Embodiment

A case where cleaning portions 109a to 109d are each implemented by a brush extending downward from the bottom surface of top plate portion 109k of cleaning slider 109 has been described in the second embodiment above, however, the construction of the cleaning portion is not limited thereto and any other construction may be employed so long as it can clean dust on discharge electrodes 103a to 103d.

An ion generation apparatus having a cleaning portion in another construction will be described below as a third embodiment, with reference to FIGS. 42 to 44.

Referring to FIGS. 42 to 44, in the present embodiment, the cleaning portion is implemented by what is called a twist brush. This twist brush is made by winding a brush material around a reinforcement material (shaft) in the center and extending the brush material outward from the reinforcement material to form a columnar shape. Two twist brushes are provided for one discharge electrode.

Specifically, two twist brushes 127b and 128b are provided in through hole 109i in a keyhole shape, and two twist brushes 127c and 128c are provided in through hole 109j in a keyhole shape.

In addition, of rectangular notch portions on opposing end portions provided in cleaning slider 109, two twist brushes 127a and 128a are provided in the rectangular notch portion on the left in the drawing and two twist brushes 127d and 128d are provided in the rectangular notch portion on the right in the drawing.

Each of twist brushes 127a, 127b, 128a, and 128b is inserted in and secured to a cleaning member attachment portion 126a provided in cleaning slider 109. In addition, each of twist brushes 127c, 127d, 128c, and 128d is inserted in and secured to a cleaning member attachment portion 126b provided in cleaning slider 109. Each reinforcement material (shaft) of each of twist brushes 127a to 127d and 128a to 128d is arranged to extend in a direction of linear movement of cleaning slider 109.

Twist brushes 127a and 128a are attached in intimate contact with and in parallel to each other, and cleaning can be performed by passing electrode 103a therebetween. A cleaning effect is improved by bringing cleaning portions 127a and 128a in intimate contact with each other to such an extent that tip ends of the brushes slightly overlap with each other.

Twist brushes 127b and 128b, twist brushes 127c and 128c, and twist brushes 127d and 128d are constructed also similarly to twist brushes 127a and 128a above.

Since the ion generation apparatus in the present embodiment is otherwise substantially the same in construction as the second embodiment described above, the same elements have the same reference characters allotted and description thereof will not be repeated.

By thus constructing the brushes, a direction of brush fibers extends in a direction substantially at the right angle with respect to the discharge electrode. Therefore, an effect to clean electrode deposits when a cleaning slider slides is enhanced.

### Fourth Embodiment

Though a construction where top plate portion 109k of cleaning slider 109 is located above the top plate portion of opposing electrode 108 has been described in the second and third embodiments above, top plate portion 109k of cleaning slider 109 may be located under the top plate portion of opposing electrode 108.

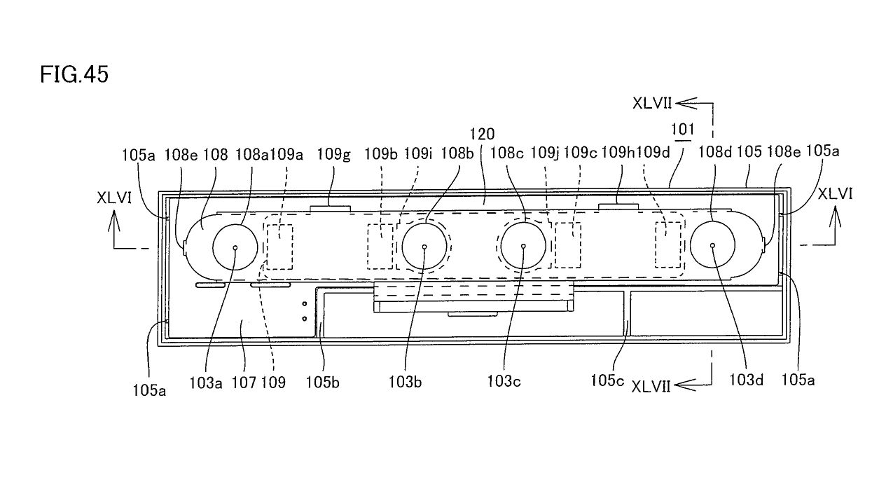

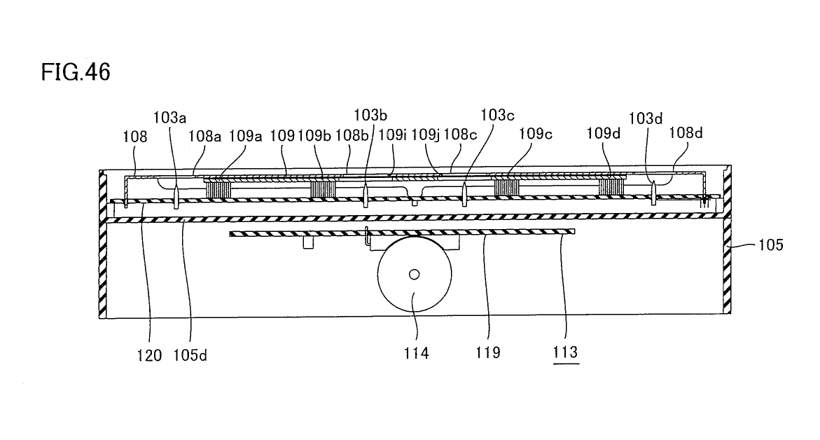

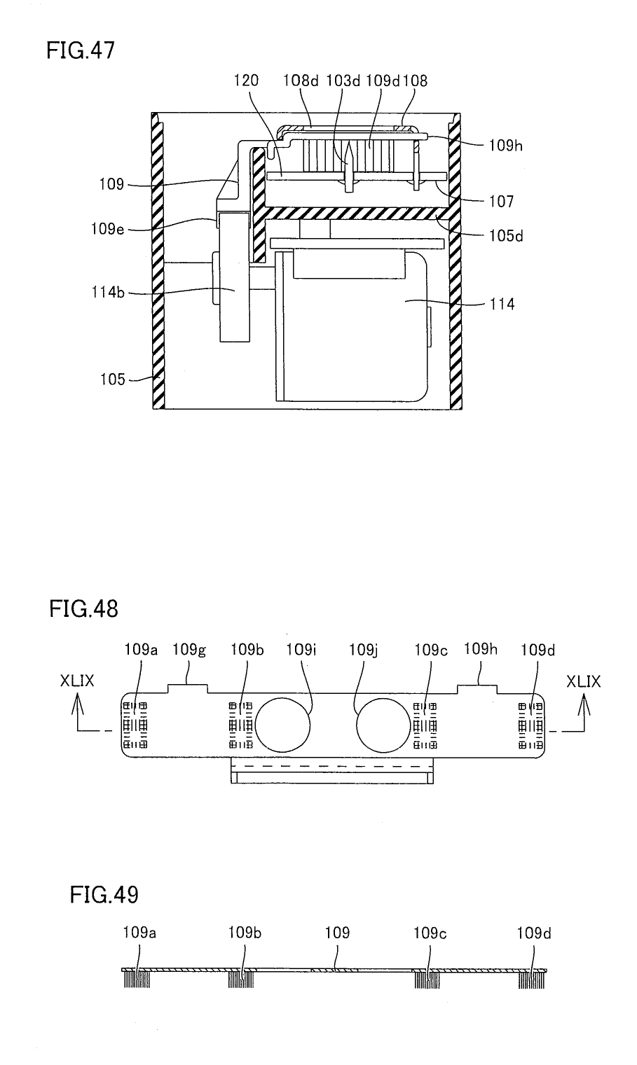

Then, an ion generation apparatus in which top plate portion 109k of cleaning slider 109 is located under the top plate portion of opposing electrode 108 will be described below as a fourth embodiment, with reference to FIGS. 45 to 50.

Referring to FIGS. 45 to 49, in the present embodiment, top plate portion 109k of cleaning slider 109 is located under the top plate portion of opposing electrode 108. Namely, top plate portion 109k of cleaning slider 109 is located on the other end side, which is opposite to the needle-like one ends of discharge electrodes 103a to 103d, with respect to the top plate portion of opposing electrode 108.

Protruding portions 109g and 109h are provided on the side opposite to side plate portion 109m of top plate portion 109k of cleaning slider 109. As these protruding portions 109g and 109h are held in opening portions in opposing electrode 108, cleaning slider 109 can be guided to opposing electrode 108.

By arranging top plate portion 109k of cleaning slider 109 under the top plate portion of opposing electrode 108, even when a two-dimensional shape of through holes (ion emission holes) 108a to 108d in opposing electrode 108 is circular, cleaning slider 109 can slide laterally, completely irrespective of the shape of through holes 108a to 108d provided in opposing electrode 108. Thus, each of brushes 109a to 109d can extend to reach the surface of support substrate 120, so that not only discharge electrodes 103a to 103d but also the surface of support substrate 120 can be cleaned.

Since the ion generation apparatus in the present embodiment is otherwise substantially the same in construction as the first embodiment described above, the same elements have the same reference characters allotted and description thereof will not be repeated.

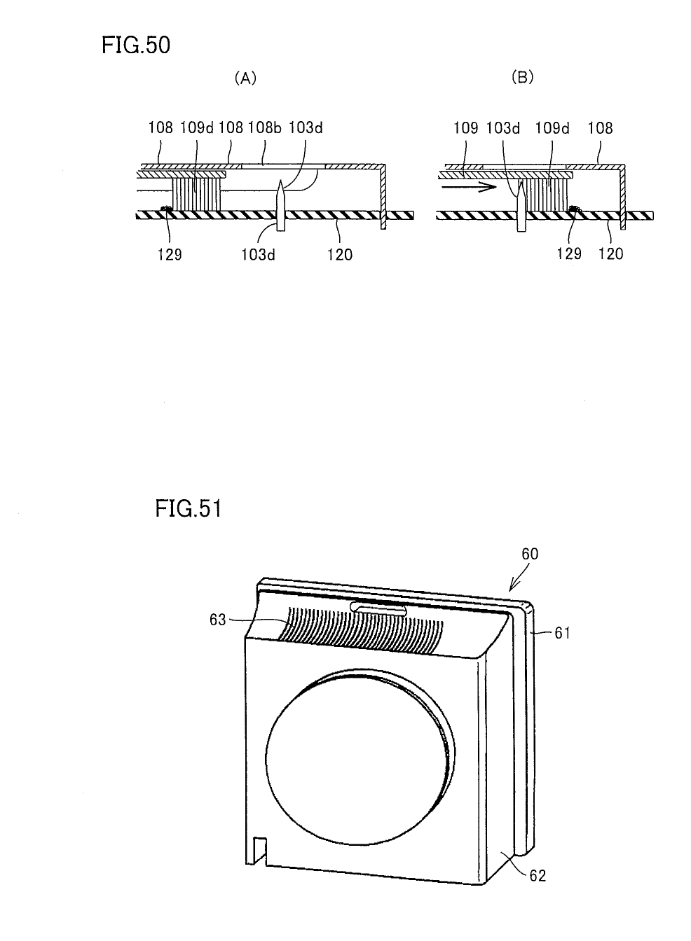

Dust 129 deposited on the surface of support substrate 120 absorbs moisture due to high humidity and its insulation lowers. This dust 129 lower in insulation may cause abnormal discharge in a path from discharge electrodes 103a to 103d→the surface of support substrate 120→a space→opposing electrode 108. In the present embodiment, as shown in FIGS. 50(A) and (B), not only discharge electrodes 103a to 103d but also the surface of support substrate 120 can be cleaned with brushes 109a to 109d as appropriate and hence such abnormal discharge can be suppressed.

### Fifth Embodiment

A construction of an air cleaner will be described as a fifth embodiment by way of example of electric equipment including an ion generation apparatus in the first to fourth embodiments above.

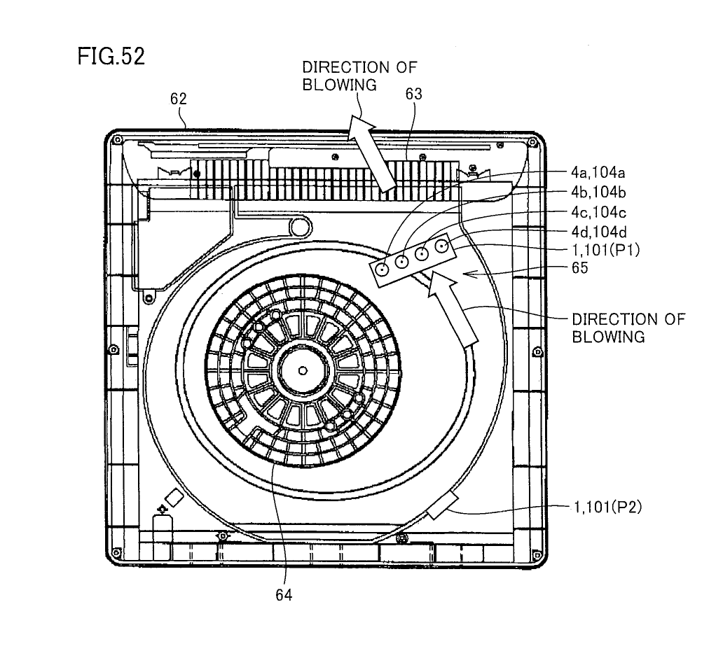

Referring to FIGS. 51 to 52, an air cleaner 60 has a front panel 61 and a main body 62. An outlet 63 is provided in an upper rear portion of main body 62, and clean air containing ions is supplied through this outlet 63 into a room. An air intake port 64 is formed in a center of main body 62. Air taken in through air intake port 64 in the front surface of air cleaner 60 is cleaned as it passes through a not-shown filter. The cleaned air is supplied from outlet 63 to the outside through a fan casing 65.

Ion generation apparatus 1 (or 101) described in the first to fourth embodiments above is attached to a part of fan casing 65 forming a path through which cleaned air passes. Ion generation apparatus 1 (or 101) is arranged such that ions can be emitted through holes 4a to 4d (or 104a to 104d) serving as the ion generation portion over an air current above. By way of example of arrangement of ion generation apparatus 1 (or 101), such positions as a position P1 in an air passage path which is relatively close to outlet 63 and a position P2 relatively far therefrom are possible. By thus allowing blown air to pass through ion generation portions 4a to 4d (or 104a to 104d) of ion generation apparatus 1 (or 101), air cleaner 60 can have an ion generation function to supply ions to the outside together with clean air through outlet 63.

According to air cleaner 60 in the present embodiment, ions (one or both of positive ions and negative ions) generated by ion generation apparatus 1 (or 101) can be sent on an airflow by means of a blowing portion (an air passage path), and hence ions can be emitted to the outside of the cleaner.

Though the air cleaner has been described by way of example of the electric equipment in the present embodiment, the present invention is not limited thereto and the electric equipment may otherwise be an air conditioning apparatus (air conditioner), refrigerating equipment, a sweeper, a humidifier, a dehumidifier, an electric fan heater, and the like, and any electric equipment having a blowing portion for sending ions over an airflow may be applicable.

In addition, power supply input to ion generation apparatus 1 (input power supply) in the above may be any of commercial AC power supply and DC power supply. In a case where the input power supply is the commercial AC power supply, a distance defined by the law should be secured between components constituting high-voltage transformer drive circuit 11 serving as the primary side circuit or between patterns on a printed board.

As a component, a component capable of ensuring a withstand voltage against a power supply voltage is required. This fact leads to increase in size, however, a circuit configuration can be simplified and the number of parts can be decreased. On the other hand, in a case where the input power supply is a DC power supply, a distance between components constituting high-voltage transformer drive circuit 11 serving as the primary side circuit or between patterns on a printed board is significantly relaxed as compared with the case of the commercial AC power supply above. Arrangement at a short distance is permitted, a small product such as a chip part can be adopted as the component itself, and high-density arrangement is permitted. On the other hand, a circuit for implementing a high-voltage drive circuit becomes complicated and the number of parts is greater than in the case of the commercial AC power supply above.

Though an example of ion generation apparatus 1 including two pairs of positive and negative ion generation portions has been described in the first to fourth embodiments above, the number of positive and negative ion generation portions is not limited to two pairs, and one pair or three or more pairs can also develop a similar structure.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

The present invention is particularly advantageously applicable to an ion generation apparatus in which contamination of a discharge portion is desirably removed and electric equipment equipped therewith.

### REFERENCE SIGNS LIST

1, 101 ion generation apparatus; 2, 102 power supply input connector; 3a to 3d, 103a to 103d discharge electrode; 4a to 4d, 104a to 104d, 108a to 108d, 109i, 109j, 120a, 120b through hole (ion emission portion); 5, 6 ion generation element; 7, 105 case; 7a support substrate holding wall; 7b spring holding portion; 7c slider holding portion; 7d protrusion; 7e solenoid guide; 7f stopper; 8 case cover; 10, 11, 108 opposing electrode (induction electrode); 10a, 10b, 11a, 11b, 108a to 108d through hole; 12 support substrate; 13 circuit unit; 15 solenoid; 15a plunger; 16 coupling plate; 16b pin portion; 17 spring; 18 arm; 18a coupling hole; 18b slider fixing portion; 18c through hole; 19 rotation shaft; 20 slider; 20a arm attachment portion; 20b, 20c cut-out portion; 20d cleaning portion support arm; 20e cleaning portion; 20f main body portion; 21 deposit removal mechanism portion; 22 thin plate made of resin; 23 brush made of resin; 30, 111 high-voltage transformer drive circuit; 31, 110 high-voltage transformer; 32a, 32b high-voltage circuit; 60 air cleaner; 61 front panel; 62 main body; 63 outlet; 64 air intake port; 65 fan casing; S bending portion; 105a substrate holding wall; 105b, 105c stopper portion; 105d interior plate; 106 cover; 107 ion generation circuit portion; 108e attachment leg; 109 cleaning slider; 109a to 109d cleaning portion; 109e rack gear; 109f position detection portion; 109g protruding portion; 109k top plate portion; 109m side plate portion; 112a lead pin; 113 motor control circuit portion; 114 motor; 114a motor terminal; 114b pinion gear; 115 motor control circuit; 117 cleaning slider position detection circuit; 118 position detection element; 119 substrate; 119a, 119b substrate attachment hole; 119c hole; 119d position detection hole; 120 support substrate; 121a, 121b connection pin attachment portion; 122, 122 high-voltage diode; 124 deposit removal portion; 126a, 126b cleaning member attachment portion; and 127a to 127d, 128a to 128d twist brush.

1. An ion generation apparatus, comprising:
a discharge electrode for generating ions; and
a cleaning member constructed to be movable between a contact state in which contact with said discharge electrode is established for cleaning said discharge electrode and a non-contact state in which contact with said discharge electrode is not established.

2. The ion generation apparatus according to claim 1, further comprising an induction electrode for generating ions between the induction electrode and said discharge electrode.

3. The ion generation apparatus according to claim 1, wherein
said cleaning member has a bending portion for converting rotational motion into linear motion.

4. The ion generation apparatus according to claim 3, wherein
said bending portion of said cleaning member is smaller in dimension in a direction of width than a portion other than said bending portion of said cleaning member.

5. The ion generation apparatus according to claim 1, wherein
said cleaning member is made of a thin metal plate.

6. The ion generation apparatus according to claim 1, configured to stop power feed to said discharge electrode while said cleaning member is in said contact state.

7. The ion generation apparatus according to claim 1, wherein
said discharge electrode has a needle-like tip end and serves to generate ions at said tip end, and
said ion generation apparatus further comprises a motor allowing said cleaning member to move.

8. The ion generation apparatus according to claim 7, wherein
said cleaning member has a rack gear, and said motor has a pinion gear engaged with said rack gear.

9. The ion generation apparatus according to claim 7, further comprising an induction electrode arranged opposed to said discharge electrode wherein
the other end opposite to the needle-like one end of said discharge electrode is located under said induction electrode, and said cleaning member is located above said induction electrode.

10. The ion generation apparatus according to claim 9, wherein
said induction electrode has a through hole for emitting ions, and said through hole has a keyhole shape formed by combining a circular portion and a rectangular portion.

11. The ion generation apparatus according to claim 7, further comprising an induction electrode arranged opposed to said discharge electrode, wherein
the other end opposite to the needle-like one end of said discharge electrode is located under said induction electrode, and said cleaning member is located under said induction electrode.

12. The ion generation apparatus according to claim 7, further comprising a substrate for supporting said discharge electrode, wherein
said cleaning member is constructed to be able to clean also a surface of said substrate simultaneously with cleaning of said discharge electrode.

13. The ion generation apparatus according to claim 7, further comprising a case accommodating at least said discharge electrode therein, wherein
said case is two-dimensionally partitioned into a region accommodating a portion transmitting drive force from said motor to said cleaning member and a region accommodating an ion generation portion including said discharge electrode, and
a part of the region accommodating said ion generation portion is molded with an insulating resin.

14. The ion generation apparatus according to claim 7, further comprising a detection member for detecting a position of movement of said cleaning member, wherein
said ion generation apparatus is configured to be able to control positional relation between said cleaning member and said discharge electrode based on a position of said cleaning member detected by said detection member.

15. The ion generation apparatus according to claim 7, wherein
said cleaning member includes at least two brush members,
each of said two brush members has
a shaft extending in a direction of movement of said cleaning member, and
a brush extending toward an outer circumference with said shaft being a center, and
said cleaning member is constructed to be able to clean said discharge electrode while said tip end of said discharge electrode lies between the two brush members.

16. Electric equipment, comprising:
the ion generation apparatus according to claim 1; and
a blowing portion for sending ions generated by said ion generation apparatus to outside of the electric equipment over a blown airflow.
